(19) United States
(12) Patent Application Publication
(10) Pub. No.: US 2026/0311036 A1
(43) Pub. Date: Oct. 8, 2026

(54) DROPOUT TRAINING FOR MULTI-AGENT COLLABORATIONS

(71) Applicant: GDM Holding LLC, Mountain View, CA (US)

(72) Inventors: Victor Carbune, Zurich (CH); Florian Nils Hartmann, Zurich (CH); Duc-Hieu Tran, Zurich (CH)

(21) Appl. No.: 19/169,950

(22) Filed: Apr. 3, 2025

(51) Int. Cl. G06N 20/00; G06Q 10/10

(52) U.S. Cl. CPC G06N 20/00; G06Q 10/103

(57) ABSTRACT

Methods and systems are provided for training a first agent for performing a task using multi-agent collaboration. A method comprises generating first output data based upon first input data and training the first agent accordingly. Generating the first output data comprises identifying other agents, determining a first set of the other agents comprising at least one of the other agents based upon a value indicating a probability that operation of the one or more other agents will change, modifying the operation of the other agents in the first set comprising modifying a process of each other agent in the first set for generating respective second output data, generating, for each of the other agents, the second output data, the second output data generated for the other agents in the first set indicative of the modified operation, and generating the first output data based upon the second output data.

### BACKGROUND

This specification relates to processing data using machine learning models, in particular machine learning models implemented as agents in a multi-agent system.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

Machine learning models may be implemented as agents and used as part of a multi-agent system with multi-agent collaboration. Multi-agent collaboration enables the capabilities of each agent in the multi-agent system to be combined to achieve more complex tasks. However, such multi-agent systems are often not robust to changes in operation of the agents or system failures over time. The techniques described herein provide a solution to this and other problems with current multi-agent systems.

According to a first aspect of the invention, there is provided a computer-implemented method for training a first agent for performing a task using multi-agent collaboration. The method comprises generating, by the first agent, first output data based upon first input data for the first agent. The method further comprises training the first agent based upon the first output data. Generating the first output data comprises identifying one or more other agents for responding to respective second input data, the respective second input data based upon at least a portion of the first input data. Generating the first output data further comprises determining a first set of the one or more other agents comprising at least one of the one or more other agents, the first set determined based upon a value indicating a probability that operation of the one or more other agents shall be modified. Generating the first output data further comprises modifying the operation of the one or more other agents part of the first set. Modifying the operation comprises modifying a process of each other agent in the first set for generating respective second output data. Generating the first output data further comprises generating, for each of the other agents, the respective second output data, wherein the respective second output data generated for the one or more other agents part of the first set is indicative of the modified operation. Generating the first output data further comprises generating the first output data based upon the second output data.

That is, generating, for each of the other agents, respective second output data may include a process undertaken by the respective other agent. The process may include processing the respective second input data using, e.g., the respective other agent's functions and/or machine learning capabilities, to generate the output. Modifying the process may include modifying the inputs/outputs (e.g., inputs/outputs to a machine learning model) to the process or steps undertaken as part the process. For example, the properties of the process may be augmented, transformed, deleted, edited, replaced, etc. in any suitable way. As will now be apparent, modifying the operation of the one or more other agents in the first set includes modifying the process of generating the respective second output data for those agents in the first set, whereas the process for generating the respective second output data for those agents not in the first set may not be modified. Such a modification of the process for the other agents that are part of the first set may therefore cause their respective second output data to be indicative of the modified operation.

In some implementations, the value is a different value for each of the one or more other agents. That is, the value (referred to herein as “probability value”) may vary for each of the other agents. By utilising different probability values for different other agents, the ego agent may be trained to take into account that particular other agents are more likely to change operation than for others. As a result, a trade-off between optimal performance and robustness may be controlled more effectively.

In some implementations, training the first agent based upon the first output data comprises updating the value. That is, the probability value may be a trainable parameter of the first agent. For example, the method may comprise initialising the probability value to a random value. During training, the probability value may be updated based upon the first output data (e.g., using supervised learning with backpropagation to minimize a loss function). By providing the probability value as a trainable parameter (i.e., by updating the probability value), the probability value may be optimized (i.e., learnt) for use in subsequent training steps and/or inference. In this way, an optimal probability value may be determined.

In some implementations, the value is determined based upon data indicative of whether the one or more other agents will not be available for responding to the respective second input data and/or a change in operation of the one or more other agents over time. That is, the probability value may be determined according to specific properties of the other agent(s). Data indicating such information may be provided and used to determine the probability value. In other examples, it may be known that a particular other agent has changed its operation over time. By taking into account whether the respective other agent will not be available and/or whether the respective other agent has changed in its operation over time (i.e., empirical data), the probability value may be accurately determined, thus enhancing the training of the first agent by training according to real-world conditions.

In some implementations, the value is determined based upon an accuracy value indicative of an accuracy for one or more previous updates of the first agent and/or a loss value indicative of a loss for the one or more previous updates of the first agent. In such implementations, the accuracy value and loss value may correspond to a proportion of the other agents that are part of the first set with respect to a total number of the other agents. By determining the probability value in this way the trade-off between accuracy and robustness may further be controlled according to the current and real-time performance of the first agent.

In some implementations, the operation of the one or more other agents in the first set comprises preventing the other agents in the first set from contributing to the generation of the first output data. That is, the second output data from each of the one or more other agents, i.e., as a product of the modified operation, may be such that contribution to the final output (i.e., the first output data) is prevented, restricted, reduced, limited, modified etc.

In some implementations, the respective second output data generated for the one or more other agents part of the first set is indicative of the modified operation by indicating an empty string of zero length, an identifier for the respective other agent, or a number, k, of predetermined tokens. By generating respective second output data that is indicative of the modified operation indicating an empty string of zero length, the first agent may be unable to rely upon output from at least one of the other agents in generating the first output data (e.g., the output from the at least one other agent provides no useful information by being “empty”). Accordingly, the first agent may be trained to not rely upon output from the at least one other agent, thereby restricting access to functionality of the at least one other agent. The empty string provides a simple mechanism for implementing the techniques described herein. By generating respective second output data that is indicative of the modified operation indicating the identifier, the first agent may be trained to not only not rely upon the at least one other agent, but may also be trained taking into account what particular other agent(s) were dropped out, thereby enhancing the first agent's internal model of what each other agent contributes to the overall output. As will now be apparent, modifying the process of each respective other agent for generating the respective second output data, as described above, may result in the respective second output data being indicative of the modified operation. For example, modifying an output of the process may include replacing the output with the empty string of zero length, the identifier for the respective other agent, or the number, k, of predetermined tokens.

In some implementations, the number, k, is determined based upon data indicative of an expected number of output tokens corresponding to the other agent part of the first set that generated the respective second output data.

In some implementations, the data indicative of an expected number of output tokens comprises a probability distribution for the expected number of output tokens. That is, statistics may be maintained for the agents that part of the first set regarding how many output tokens those agents usually emit (i.e., output).

In some implementations, generating the respective second output data indicating the number, k, of predetermined tokens comprises generating, for each of the other agents that are part of the first set, tentative output data based upon the respective second input data, the tentative output data comprising one or more output tokens. Generating the respective second output data indicating the number, k, of predetermined tokens may further comprise modifying the tentative output data by replacing each of the one or more output tokens with a predetermined token to generate the respective second output data indicating the number, k, of predetermined tokens. That is, in some examples, the number, k, of special tokens may be generated by actually generating a response from the at least one other agent and simply masking that response (i.e., with the predetermined special token). In other words, the tentative output data may be generated as actual output data from the other agent and each token of that response may be replaced with the predetermined special token. In this way, the number, k, may be determined empirically and the number, k, of special tokens may be generated accordingly. By generating respective second output data that is indicative of the modified operation indicating the number, k, of special tokens, positional encodings of the first agent (i.e., of a machine learning model of the first agent) are uninterrupted. Positional encodings, e.g., positional embeddings (i.e., vectors), are used to indicate to a machine learning model a position of one or more tokens in the input. Significant changes in the expected model input (e.g., by reducing otherwise lengthy output from the at least one other agent to, for example, an empty string of zero length or agent identifier) may interfere with positional encodings of the first agent that were learnt during previous training steps. Accordingly, the number, k, of special tokens both indicates the modified operation of the other agent whilst not affecting the positional encodings of the first agent once the second output data is incorporated as input to the first agent for generating the first output data.

In some implementations, modifying the operation of the one or more other agents part of the first set comprises adjusting a temperature parameter for each of the other agents that are part of the first set. Modifying the operation of the one or more other agents part of the first set may further comprise modifying the respective second input data for each of the other agents that are part of the first set. Modifying the operation of the one or more other agents part of the first set may further comprise modifying, for each of the other agents that are part of the first set, an embedding vector of the respective second input data in a machine learning model of the respective other agent that is part of the first set. That is, aside from modifying the operation of the other agent(s) to cause the other agent(s) to emit e.g., an empty string of zero length, an identifier, or number, k, of special tokens, modifying the other agent(s) may comprise modifying a machine learning model of the other agent(s). For example, rather than directly modifying the output of the other agent(s) (e.g., by bypassing the machine learning model entirely and replacing its output), the machine learning model itself may be adapted. By adjusting the temperature parameter in this way, the first agent may be trained to not rely upon exact capabilities of the other agents part of the first set, and in particular to not rely upon expected operation of the other agents. By modifying the respective second input data, or an embedding thereof, the operation of the other agent may be modified such that the other agent(s) behaviour and/or functionality for the particular inference cycle of the other agent for the respective second input data is adapted in ways that would not otherwise be possible to achieve, e.g., when compared to behaviour and/or functionality resulting from using the unmodified second input data. Put another way, the behaviour and/or functionality of the other agents(s) may in some examples be temporarily modified by modifying the other agent(s) input. In this way, the process of training the first agent may be enhanced taking into account the different possibilities in behaviour and/or functionality of the other agent(s).

In some implementations, identifying the one or more other agents for responding to a respective second input data comprises processing the first input data using a first machine learning model of the first agent, the first machine learning model, in response, further determining the respective second input data for each of the one or more other agents. That is, the first agent may use the first machine learning model to process the first input data to generate an output, such as an output indicating a function call for one or more of the other agent(s). Such an output may include an extracted input parameter (i.e., the second input data) and data, e.g., text data, indicating a function call for each extracted input parameter that identifies the invoked other agent. That is, in some examples, identifying the one or more other agents for responding to a respective second input data further comprises outputting, from the first machine learning model, data identifying the one or more other agents. In some examples, the data identifying the one or more other agents indicates one or more function calls. An intermediate process or framework may parse the output (e.g., text indicating the function call) to identify the other agent(s) and thus execute the function call(s). For example, the output may include text in a JSON format and the intermediate process may be configured to parse the output and identify the particular function (and other agent) for execution from e.g., the JSON text. The function call(s) to other agent(s) (i.e., invocation of a respective other agent) may include a remote call (e.g., API call over a computer network such as the internet) to the other agent(s). The remote call may include the respective second input data (i.e., as an input parameter for the function) and optionally authentication token(s) in the event that they are required. The function call(s) to the other agent(s) may thus be executed as an intermediate step in generating the first output data.

In some implementations, the method further comprises training a second machine learning model to output a prediction for the value based upon a training dataset and outputting the trained second machine learning model for use. The training dataset may comprise input training data indicating an input for at least one of the other agents. The training dataset may further comprise a training value indicating a probability that the at least one other agent will not be available for responding to an input. By training the second machine learning on such data, the second machine learning may be used during inference to accurately predict the probability value for any given input (e.g., the first input data).

In some implementations, the method further comprises, for each of the other agents generating, for the respective other agent, third output data based upon third input data for the respective other agent. The method may further comprise, for each of the other agents, training the respective other agent based upon the third output data. Generating the third output data may comprise identifying one or more second other agents for responding to respective fourth input data, the respective fourth input data based upon at least a portion of the third input data. The one or more second other agents may comprise the first agent and the one or more other agents excluding the respective other agent. Generating the third output data may further comprise determining a second set of the one or more second other agents comprising at least one of the one or more second other agents. The second set may be determined based upon a second value indicating a probability that operation of the one or more second other agents shall be modified. Generating the third output data may comprise modifying the operation of the one or more other agents part of the second set. Generating the third output data may comprise generating, for each of the second other agents, respective fourth output data. The respective fourth output data generated for the one or more other agents part of the second set may be indicative of the modified operation. Generating the third output data may comprise generating the third output data based upon the fourth output data. By iterating the training process across all agents (i.e., treating each other agent and first agent as the ego agent, as may be the case), the techniques described herein may be leveraged to improve all of the agents for multi-agent collaboration such that collaboration between agents is also improved. That is, the foregoing process for generating the third output data may be the same or similar process to the process previously described for generating the first output data, i.e., where the role of one of the other agents is the first agent and where the role of the agent previously acting as the first agent is one of the other agents.

In some implementations, the first input data comprises text data, image data, audio data, video data, sensor data, or time-series data. In some implementations, the first output data comprises text data, image data, audio data, video data, signal data, or categorical data. In some implementations, the task comprises a classification task, a control task for a robotic device, a machine translation task, a summarization task, a question-answering task, a data generation task, or a signalling task.

In some implementations, the task is a task for a real-world environment, and wherein the first agent is configured to control one or more mechanical and/or electronic devices for performing the task in the real-world environment.

According to a second aspect of the invention, there is provided a computer-implemented method for performing a task using multi-agent collaboration. The method comprises receiving, by a first agent, first input data for the first agent, the first agent comprising a first machine learning model, the first machine learning model including an attention layer. The method further comprises identifying one or more other agents for responding to respective second input data, the respective second input based upon at least a portion of the first input data. The method further comprises generating, for at least one of the other agents, respective second output data based upon the respective second input data for the at least one other agent, the respective second output data comprising at least one token. The at least one other agent corresponds to a value indicating a probability that operation of the one or more other agents was modified during a training phase of the first agent. The method further comprises generating first output data by providing at least the second output data as input to the first agent. Generating the first output data comprises identifying one or more outputs of the attention layer corresponding to the at least one token. Generating the first output data further comprises modifying the one or more outputs based upon the value. The method further comprises performing, by the first agent, the task based upon the first output data.

In some implementations, modifying the one or more outputs based upon the value comprises downscaling the one or more outputs based upon the value. The one or more outputs may be one or more attention layer activations of the attention layer. By downscaling the relevant outputs which may have undergone upscaling, such an affect may be remediated.

In some implementations, the value is determined by providing the first input data as input to a trained machine learning model to output the value. By leveraging the training machine learning model, as previously described with reference to training, an accurate prediction for the probability value may be determined and used for purposes as just described.

In some implementations, the method further comprises determining the value based upon availability data indicating whether the at least one of the other agent is not available for responding to input. In some examples, the availability data may be obtained from system logs, historical records, heuristics, and/or via API calls. By taking into account the availability of the other agent(s) in determining the probability value, the probability value used for modification of the outputs, as previously described, may be controlled accordingly.

According to a third aspect of the invention, there is provided a computer-implemented method for performing a task using multi-agent collaboration. The method comprises receiving, by a first agent, first input data for the first agent. The method further comprises generating, by the first agent, first output data based upon the first input data for the first agent. Generating the first output data comprises identifying one or more other agents for responding to respective second input data, the respective second input based upon at least a portion of the first input data. Generating the first output data further comprises generating, for at least one of the other agents, second output data based upon the respective second input data for the at least one other agent. Generating the first output data further comprises generating first output data by providing at least the second output data as input to the first agent. The method further comprises performing, by the first agent, the task based upon the first output data. The first agent has been trained according to the method described with reference to the first aspect of the invention.

According to a fourth aspect of the invention, there is provided a distributed computing system comprising a first computing device implementing a first agent, the first agent configured to process first input data to generate first output data, the first agent trained according to the method described with reference to the first aspect of the invention. The distributed computing system further comprises a second computing device implementing another agent, the other agent configured to process second input data to generate second output data. The second computing device is further configured to receive the second input data from the first computing device over a computer network and to transmit the second output data to the first computing device over the computer network. By providing such a distributed computer system, e.g., a multi-agent system distributed across multiple computer connected by a network, in which the first agent has been trained for multi-agent collaboration with agent dropout, the distributed system is robust to defects that may occur in the computer network and/or the operation of the other agent. Such defects could include a communication link in the network or a server implementing the other agent failing. In this way, the first agent may maintain performance despite such occurrences.

According to a fifth aspect of the invention, there is provided a computer-implemented method for training a first agent for performing a task using multi-agent collaboration, the method comprising generating, by the first agent, first output data based upon first input data for the first agent and training the first agent based upon the first output data. Generating the first output data comprises identifying one or more other agents for responding to respective second input data, the respective second input data based upon at least a portion of the first input data, simulating operation of the one or more other agents by an agent simulator to provide one or more simulated other agents, determining a first set of the one or more simulated other agents comprising at least one of the one or more simulated other agents, the first set determined based upon a value indicating a probability that operation of the one or more simulated other agents will change, modifying the simulated operation of the one or more other agents in the first set, and generating, for each of the simulated other agents, respective second output data. The respective second output data generated for the one or more simulated other agents in the first set is indicative of the modified simulated operation. Generating the first output data further comprises generating the first output data based upon the second output data.

In other words, the techniques described herein with respect to the use of other agent(s), e.g., during training, may be applied where the agents are simulated or emulated rather than being directly used. The agent simulator may be implemented by any suitable computer program on one or more computing devices. The agent simulator may simulate/emulate one or more of the other agents in any suitable way, e.g., using one or more functions and/or machine learning models. In some examples, the machine learning models on which the original other agent(s) are based may be reproduced and used for the simulation/emulation. The simulation/emulation of the other agent(s) may result in the same or similar operation of the other agent(s) during the simulation/emulation. The simulation/emulation may be based upon historical records of the other agent(s) performing their operation(s), e.g., based upon records of their inputs and outputs. For example, the simulation/emulation may utilise a logic-based function based upon the historical records and/or a machine learning model that has been trained based upon the historical records. In specific examples, the simulation/emulation may utilise imitation learning and/or machine learning model distillation. That is, the simulation/emulation may be provided by a machine learning model that has been trained using an imitation learning technique to imitate the behaviour and/or functionality of a machine learning model of one of the other agent(s). Likewise, the simulation/emulation may be provided by a machine learning model that is the product of performing model distillation on a machine learning model of one of the other agent(s). By simulating the other agent(s), efficient training of the first agent may be provided without requiring availability or access to the other agent(s) at any given moment, which may be useful in the event that the other agent(s) are unavailable or where remote/offline training is required (e.g., where operation of the other agent(s) requires access over a computer network such as the internet).

There is also described herein a computing system comprising one or more processors and one or more non-transitory computer-readable media storing computer-readable instructions configured to perform any of the methods as set out above.

There is also described herein one or more non-transitory computer-readable media storing computer-readable instructions configured to cause one or more computing devices to perform any of the methods as set out above.

Particular embodiments of the subject matter described in this specification can be implemented so as to realize one or more of the following advantages.

The techniques described herein enable multi-agent systems to be trained to be more robust to changes in operation (e.g., an agent starts to perform poorly or undergoes further training for a different task than what the agent was originally trained for), system failures (e.g., a server crashing that implements one or more of the agents in the system), lack of availability of a given agent (e.g., an agent is busy and unavailable for processing data), etc. Such occurrences may negatively affect the performance of agents in the system because each agent may depend upon one or more of the other agents. It is thus desirable to provide a practical solution to this problem. Specifically, in multi-agent systems, agents can become overly reliant on the particular capabilities and outputs of other agents. The over-reliance may be a direct result of the agent's training, e.g., where utilising other agents minimizes their objective or loss function. However, this over-reliance can lead to poor generalization, reduced performance, and system instability when the other agents are unavailable or their behaviour changes, for example. That is, reliance on a particular capability of an other agent that suddenly is not available or altered may result in a less than suitable response from the first agent because the first agent may not have been properly trained to handle queries independently. Accordingly, the techniques described herein permit the use of multi-agent collaboration whilst providing a solution to this, i.e., the problem that agents in the system may otherwise become overly reliant or dependent upon the capabilities of other agents, and other problems.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 schematically depicts a multi-agent collaboration system.

FIG. 2 schematically depicts other agents for agent dropout.

FIG. 3 schematically depicts an example of multi-agent collaboration.

FIG. 4A schematically depicts a probability value for agent dropout.

FIG. 4B schematically depicts a training dataset for training a machine learning model for agent dropout.

FIG. 5A schematically depicts a first agent trained using agent dropout and provided for inference.

FIG. 5B schematically depicts an input to a machine learning model including an attention layer.

FIG. 6 depicts a flow diagram of a method for training a first agent for performing a task using multi-agent collaboration.

FIG. 7 depicts a flow diagram of a method for performing a task using multi-agent collaboration.

Like reference numbers and designations in the various drawings indicate like elements.

### DETAILED DESCRIPTION

Agents are machine learning based systems that may be implemented as one or more computer programs on one or more computers. Such agents may be configured to receive an input and generate an output in response, i.e., for performing a task. Agents may be trained to perform tasks by e.g., training the machine learning models upon which they are based using any suitable method. Large Language Models (LLMs), along with other types of machine learning models, may be integrated as agents within multi-agent systems, transforming how complex tasks are approached and solved. That is, to solve complex problems, an agent receiving an initial input (referred to herein as “ego agent”) may collaborate or interact with external agents (referred to herein as “other agents”) to come to a solution (i.e., to generate a response). For example, an input for the ego agent may be “Write me a function in Python for solving a quadratic equation”. In this example, the ego agent may not have been trained to produce functioning Python code and/or to produce correct mathematical formula on which the Python code is based. As such, the ego agent may interact with other agents that have been specifically trained for such purposes or that offer generally better performance than the ego agent. Accordingly, the other agents may be leveraged to generate a more suitable response to the input provided by a user.

However, a number of problems exist with current implementations of multi-agent systems. Often the ego agent tends to overfit to the other agents because the ego agent learns specifically to collaborate with the other agents during training, e.g., in the event that the user's input is particularly complex or difficult for the ego agent to respond to. That is, the ego agent when trained for multi-agent collaboration often becomes overly reliant upon functionality of the other agents, rather than directly responding to the input based upon its own capabilities. Overfitting is a concept in machine learning whereby a machine learning model becomes too adapted to its training set and therefore does not generalise well when presented with examples not in that set (i.e., unseen data). Overfitting in the context of multi-agent collaboration is particularly detrimental to performance for the following reasons. An example definition of what overfitting is in the context of multi-agent collaboration is when the first agent, as previously described, becomes reliant, adapted, or dependent upon the one or more other agents, also as previously described, for generating the first output data. The extent to which the first agent becomes reliant, adapted, or dependent upon the one or more other agents (e.g., overly, too, or exceedingly reliant, adapted, or dependent upon the one or more other agents) may be objectively measured in any suitable way (e.g., using evaluation metrics during training, similarly to how regular overfitting is assessed). As may be the case with regular overfitting, overfitting in the context of multi-agent collaboration can lead to a poor ability of the first agent to generalise, which can be detrimental to performance for the reasons previously described.

First, operation of the other agents may change at arbitrary times because those other agents may be provided by third party entities (e.g., company A controls the ego agent, whereas company B controls the other agent(s)). A consequence of this may be that the other agents undergo further fine-tuning over time that changes their operation (e.g., functionality or behaviour), thereby affecting their performance. For example, trained machine learning models routinely undergo further training operations to try to either improve their performance or produce different results. These further training operations inevitably change operation of the agents over time by affecting change in the parameters of the models on which the agents are based. System prompts (e.g., instructions for the agent that define how the agent should operate) may also be subject to change, e.g., by third party entities. That is, a predefined format and/or content of system instructions (e.g., “You are an expert in the field of mathematics configured to respond to questions in a logical and concise manner”) that is provided as input to a machine learning model of the agent, e.g., to influence the agent's behaviour, may also change. Tools available for use by the agent may also be subject to change. For example, functions that the agent relies upon for generating its output may be discontinued or replaced by other functions with different functionality that produces different results, thereby resulting in a change in operation of the agent as a whole.

A change in operation of the other agents can significantly impact the operation of the ego agent, such as causing the ego agent to become less stable, predictable, or to lack adequate performance. Second, the other agents may be complex in nature (i.e., the models upon which the other agents are based may include millions if not billions of parameters) and generally have great influence on the ego agent's output. Consequently, the potential to overfit to the other agents is high. Third, the other agents may become unavailable (e.g., offline or “busy”) without notification which could catastrophically impact the performance of the ego agent (e.g., cause the ego agent to exhibit poor performance). It is therefore desirable to train the ego agent to perform well even when the other agents are not available, while still training the ego agent for participating in multi-agent collaboration (i.e., such that the ego agent interacts as part of the multi-agent system without becoming overly reliant on any other agent). The methods and systems described herein are directed to addressing these and other problems, and to improving the robustness of agents interacting as part of the multi-agent system.

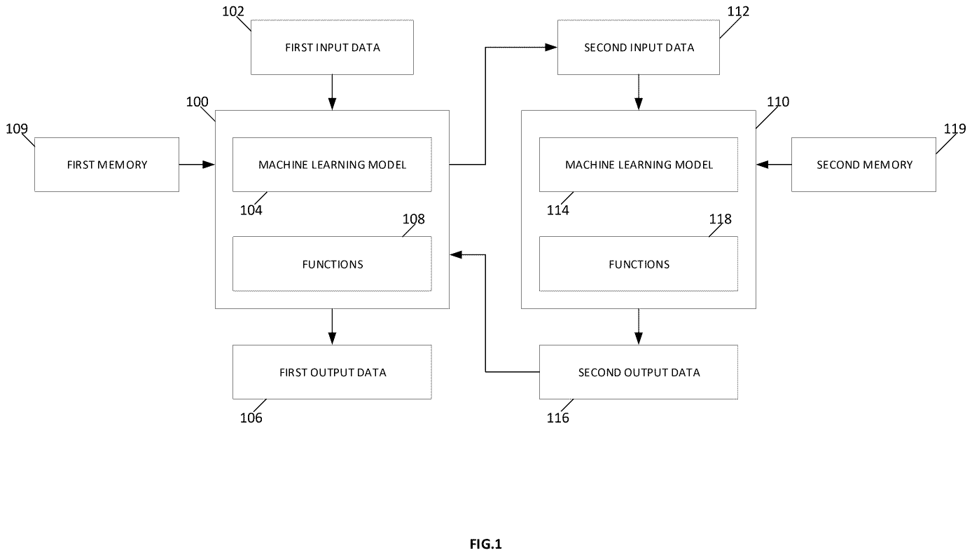

FIG. 1 schematically depicts a general overview of a multi-agent system for multi-agent collaboration, as previously described. There is depicted a first agent 100 (i.e., the ego agent) and another agent 110. The first agent 100 may comprise a machine learning model 104 and one or more functions 108. Likewise, the other agent 110 may comprise a machine learning model 114 and one or more functions 118. Both the first agent 100 and the other agent 110 may be configured to receive input and generate output data in response. The first agent 100 may generate output data by processing inputs using the machine learning model 104 and/or the functions 108. For example, the machine learning model 104 may be configured to receive text and generate an output in response to that text. In this example, the functions 108 may be natural language processing functions configured to process the text. The input may be provided by a user. The input may be, for example, text provided to the respective agent such as “Write me some code in Python for solving quadratic equations”. The input may be received in any suitable form (e.g., data indicating the input) and may comprise inter alia text, images, video, audio. For example, the machine learning model 104 may be a multi-modal model configured to receive audio data representing a person speaking “Write me some code in Python for solving quadratic equations” and output a response (i.e., output data) to that audio.

As depicted in FIG. 1, the first agent 100 may receive first input data 102. For example, the first input data 102 may be the text “Write me some code in Python for solving quadratic equations”. The first agent 100 in this example may not have been trained to generate code and/or for understanding mathematical concepts. In another example, the first input data 102 may be the text “Please can you translate the following text: “Bienvenido a Barcelona”. Can you also give me some sightseeing advice for Barcelona?”. The first agent 100 in this example may not have been trained to perform translation related tasks. As will become readily apparent, the first agent 100 may collaborate with the other agent 110, e.g., if the other agent 110 has been trained to translate text into Spanish, to respond to a query in the first input data 102. In this way, performance of the first agent 100 may be supplemented by the other agent 110.

To achieve this, the first agent 100 may generate second input data 112 from the first input data 102 using its machine learning model 104 and/or its functions 108. For example, the first agent 100 may process the first input data 102 using any rule-based, heuristic, or machine learning based function to generate the second input data 112.

For example, the functions 108 of the first agent 100 may include a natural language processing function configured to process the first input data 102 to extract sentences of text containing particular words or phrases (e.g., words or phrases relevant to translation tasks). As such, in the example above, the functions 108 may extract “Please can you translate the following text: “Bienvenido a Barcelona”.” as the second input data 112.

The first agent 100 may identify the other agent 110 based upon a predetermined mapping. The predetermined mapping may be a mapping between particular keywords contained within the extracted sentence (e.g., “translate”) and the other agent 110. For example, the predetermined mapping may be {word: “translate”, agent: “translateAgent”, . . . }. The second input data 112 may then be provided to the other agent 110 as input, e.g., over a network or directly if both agents are running on the same local system. In some examples, the second input data 112 is provided to the other agent 110 via an application programming interface (API).

The machine learning model 104 may be configured to process the first input data 102 to generate text indicating a function call. As used herein, the text indicating the function call is any text which, when parsed by e.g., the functions 108, causes a function to be executed. That is, the machine learning model 104 may process the first input data 102 and output text data indicating a function call including the second input data 112. In other words, the output text data indicating the function call may include both text indicating a specific function to be executed and the parameters/inputs (e.g., data for processing, authorization tokens, etc.) for that specific function. Execution of the function, i.e., via the function call, may include providing the parameters/inputs to the function for processing. For example, the machine learning model 104 may process “Please can you translate the following text: “Bienvenido a Barcelona”. Can you also give me some sightseeing advice for Barcelona?” and in response output “{“model: “translateAgent”, prompt: “Please can you translate the following text: “Bienvenido a Barcelona”.”}”. Such an output, when parsed by the functions 108 of the first agent 100, may cause the second input data 112 to be provided as input to the other agent 110. That is, the functions 108 may parse the output of the machine learning model 104 for function calling other agents 110. In some examples, the function executed via the function call is another one of the functions 108 of the respective agent. As will now be apparent, the first agent 100 may operate a process (e.g., one or more intermediate functions or a framework for the operation of the first agent 100) for parsing output from the machine learning model 104 prior to providing the first output data 106, i.e., for determining whether text indicating the function call has been generated, thus whether a function should be executed. If the process determines that the function should be executed, the process may execute that function. A same or similar process may occur for the other agent(s) 110 using output from the machine learning model 114 and the functions 118, e.g., to function call other agents, perform one or more other functions, or indeed provide data (e.g., the second output data 116) to the first agent 100 for generating the first output data 106.

There may be multiple ones of the second input data 112 extracted from the first input data 102. Likewise, there may be multiple ones of the other agent 110 for responding to at least a portion of the first input data 102. For example, one of the other agents 110 may have been trained specifically for responding to queries related to travel, and may therefore be employed to respond to the query “Can you also give me some sightseeing advice for Barcelona?” in the first input data 102. The other agent 110 may, in some examples, respond to the entire first input data 102 rather than a portion. The first agent 100 may interact with the other agent 110 by any suitable means (e.g., function calling as previously described). This may include providing the second input data 112 as an input parameter to a function, e.g., the functions 108, that invokes the other agent 110 via an application programming interface (API).

Once the other agent 110 receives the second input data 112, the other agent 110 may generate second output data 116 in response, e.g., by providing the second input data 112 as input to its machine learning model 114. For example, the other agent 110 may generate text data indicating “The text is in Spanish and reads “Welcome to Barcelona”.” in response to the second input data 112 being “Please can you translate the following text: “Bienvenido a Barcelona”.”. The second output data 116 may be provided back to the first agent 110 for further processing, e.g., over a network and/or via an API. In some examples, the second input data 112 is generated based upon the functions 118 of the other agent 110, e.g., by augmenting the output from the machine learning model 114.

Accordingly, the first agent 100 may generate first output data 106 based upon the second output data 116 received from the other agent 110. For example, the machine learning model 104 may, in response to receiving an input comprising the second output data 116, output the first output data 106. In examples where there are multiple ones of the other agent 110, the input to the machine learning model 104 may be based upon multiple second output data 116 from each of the other agents 110. That is, in the example where the second output data 116 is text data indicating “The text is in Spanish and reads “Welcome to Barcelona”.”, the machine learning model 104 may receive an input that incorporates that information. The input to the machine learning model 104 may be in any suitable form and may in some examples also include the first input data 102 (e.g., original query) as well as the second output data 116. In other examples, the first agent 100 may access a first memory 109 (e.g., a vector store for retrieval augmented generation) to augment the input to the machine learning model 104. Likewise, the other agent 110 may do the same with a second memory 119 when generating the second output data 116. The second output data 116 may undergo further processing (e.g., by the functions 108 of the first agent 100) before being provided as input to the machine learning model 104 to generate the first output data 106. That is, the second output data 116 may be augmented before being provided as part of the input to the machine learning model 104. The process described above may, in some examples, occur over multiple orders or rounds. For example, the other agent 110 may perform the same process described above with different other agents to generate the second output data 116.

As a result of the foregoing process, the first agent 100 generates the first output data 106 in response to the first input data 102 by using the other agent 110, and may provide the first output data 106 as output (e.g., to a user that provided the first input data 102 in the case of inference, or as an output for training purposes). This process may occur during both training and inference stages for the first agent 100. That is, the first agent 100 may be trained, e.g., using supervised learning, to interact and collaborate with the other agent 110 for inference, and may be inferred at a later stage utilising one or more of e.g., the other agent 110.

During training, the first output data 106 may be used to train or “update” the first agent 100, e.g., parameters of the machine learning model 104 of the first agent 100 may be updated by a training algorithm. The first agent 100 may be updated in any suitable way based upon the first output data 106. The machine learning models 104, 114, prior to training, may both be pre-trained models. That is, those models may have been trained on one or more tasks prior to being specifically trained for multi-agent collaboration. The first agent 100 and the other agent 110 may both undergo the process of training (i.e., updates) as described herein at different iterations. That is, in some examples, the other agent 110 takes the place of the ego agent (i.e., the first agent 100) and the first agent 100 acts as the other agent 110. This may occur for each other agent 110 in the case that there are multiple other agents 110. In each case, the other agent 110 is not updated, e.g., parameters of the machine learning model 114 remain static.

In examples, training may consist of using a training dataset (not depicted). The training dataset may comprise one or more pairs of training examples. For example, a training example could include training input data for the first agent 100, such as the first input data 102, and corresponding ground truth data. The training dataset may be a training dataset configured for training the first agent 100 for multi-agent collaboration. That is, the ground truth data may take into account that other agents are available for collaboration, i.e., by including data that was generated using the other agent 110. The first input data 102 may be provided to the first agent 100 to output the first output data 106 in response. The training algorithm may compare the first output data 106 with the ground truth data to calculate a loss in any suitable way. Accordingly, the loss may be used to update or train the first agent 100 (e.g., the machine learning model 104), for example using backpropagation with gradient descent. Training may include the use of any appropriate gradient descent optimization algorithm, e.g., Adam or another optimization algorithm.

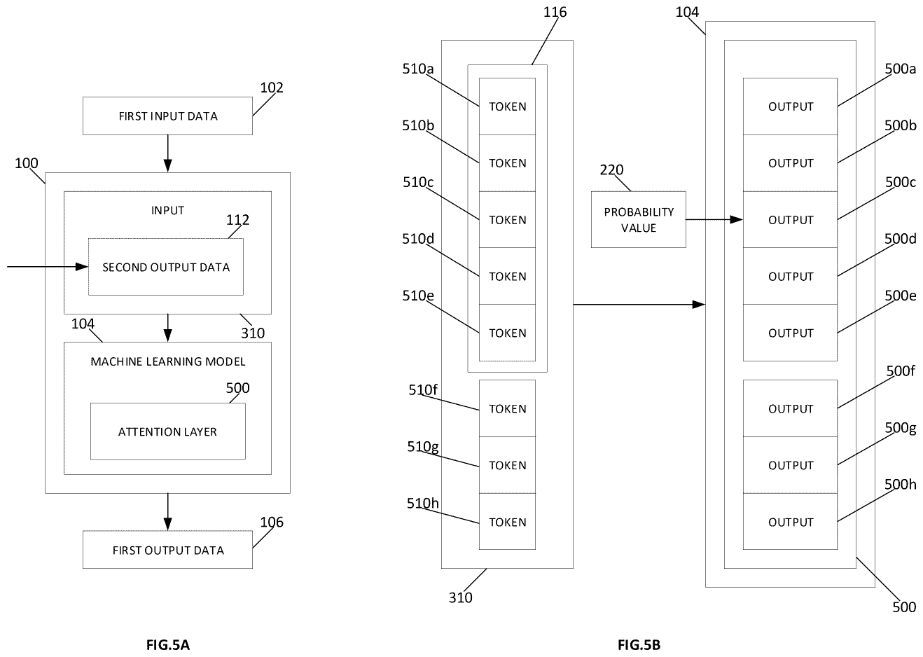

Alternatively, or in addition, the first agent 100 may be updated using reinforcement learning. That is, a reward value (not depicted) may be computed for the first agent 100 based upon an objective function for the first agent 100 and the first output data 106. The objective function may be any function (e.g., linear or parametric function) that evaluates a performance of the first agent 100 in an environment. The environment may be, for example, an abstract environment in which the first agent 100 performs actions (i.e., outputs the first output data 106) and receives feedback on those actions in the form of the reward. As mentioned, any suitable method may be used to train the first agent 100 to output the first output data 106. Once trained, the first agent 100 may be provided for inference including multi-agent collaboration. Aspects of inference once training is completed are discussed with reference to FIG. 5A below.

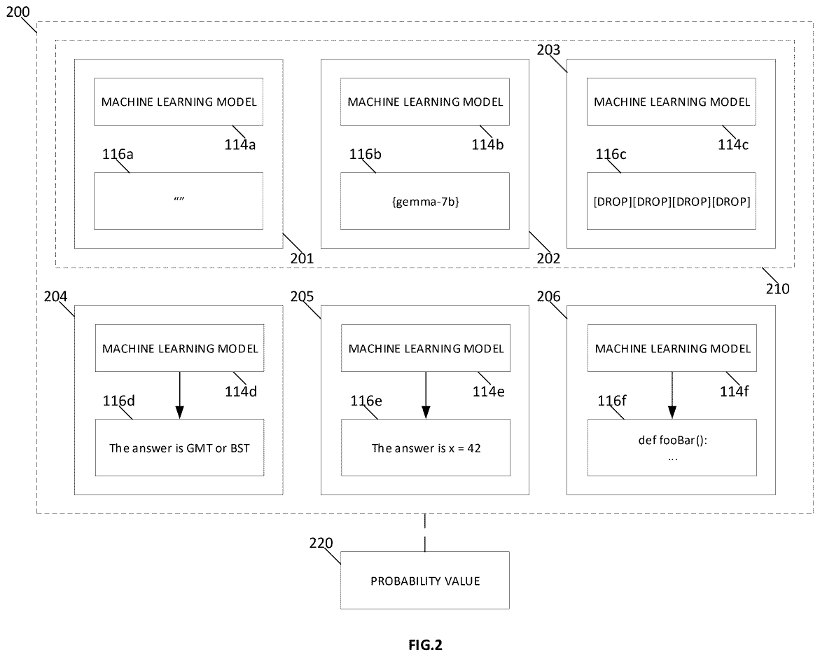

FIG. 2 schematically depicts a plurality of other agents 200 (e.g., the other agent 110 of FIG. 1) that may be available during training. The same other agents 200 may also be available during inference. That is, the other agents 200 may include all agents in which the first agent 100 is configured to collaborate with, which may be predetermined prior to training and in some examples accessed by the training algorithm to facilitate training. As previously described, the other agents 200 may change in operation over time (e.g., become unavailable, or lose/change functionality). It is therefore desirable to train the first agent 100 to be robust to changes in the other agents 200 (e.g., not become overly reliant upon the other agents 200) for generating the first output data 106. To prevent the first agent 100 becoming overly reliant upon the plurality of agents 200, operation of one or more of the other agents 200 may be modified during a training phase of the first agent 100. As referred to herein, “modifying operation” encompasses any aspect of modifying a functionality or behaviour of e.g., the other agent 110, such as modifying the other agent's 110 input/output, modifying the other agent's 110 machine learning model 114 and/or its functions 118. A type of modification may be referred to herein as “agent dropout” or “dropout”. Agent dropout may include modifying the operation of one or more of the other agents 200 in such a way to reduce reliance, adaption, or dependency of the first agent 100 on the one or more other agents 200 when generating the first output data 106. An example definition of “agent dropout” may be the prevention or restriction of a respective other agent (e.g., via the respective second output data 116) from contributing to the generation of the first output data 106. To this end, a first set 210 of the other agents 200 is determined. The first set 210 comprises at least one of the other agents 200, i.e., at least one of the other agents 200 whose operation shall be modified. The first set 210 is determined based upon a probability value 220. The probability value 220 may indicate a probability that operation of the one or more other agents shall be modified. For example, the probability value may be 0.5 and may thus, on average, cause operation of half of the other agents 200 to be modified.

That is, during a training phase of the first agent 100, a training algorithm (i.e., an algorithm that controls the training phase) may determine the probability value 220, such as a probability of 0.5. However, the probability value 220 may be determined in one or more ways and may, in some examples, be determined dynamically (i.e., may change during the training phase). In one example, to determine which of the other agents 201, 202, 203, 204, 205, 206 are part of the first set 210, the training algorithm may generate, for each of the other agents 200, a random (or pseudo-random) value between 0 and 1. If the generated random value is above the probability value (e.g., 0.5), the respective other agent may be included in the first set 210. If the value is below or equal to the probability value, the respective other agent may not be included in the first set. As depicted in FIG. 2, other agent A 201, other agent B 202, and other agent C 203 are included in the first set 210, which may be the case for a probability value 220 of 0.5. Any suitable probability value 220 is envisaged. In some examples, the probability value 220 may be a value of 0, 0.1, 0.2, 0.3, 0.4, 0.5, 0.6, 0.7, 0.8, 0.9, or 1. In some examples, the probability value 220 may be a value in a range of 0 to 0.1, 0.1 to 0.2, 0.2 to 0.3, 0.3 to 0.4, 0.4 to 0.5, 0.5 to 0.6, 0.6 to 0.7, 0.7 to 0.8, 0.8 to 0.9, or 0.9 to 1. In some examples, the probability value 220 may be a value in a range of 0 to 0.2, 0.2 to 0.4, 0.4 to 0.6, 0.6 to 0.8, or 0.8 to 1. In some examples, the probability value 220 may be a value in a range of 0.2 to 0.5 or 0.5 to 0.8. In general, the probability value 220 may indicate a probability that any one of the other agents 201, 202, 203, 204, 205, 206 may be included in the first set for modifying their operation. That is, the first set 210 includes other agents whose operation is to be modified. The other agents 200 part of the first set 210 may be determined in any suitable way.

As a result, operation of the other agents 201, 202, 203 part of the first set 210 may be modified, e.g., by the training algorithm. Operation of the other agents that are part of the first set 210 may be modified in one or more ways to achieve the described advantages. As indicated in FIG. 2, operation of the other agents that are part of the first set 210 are modified. That is, the other agent A 201 has been modified such that its respective second output data 116a indicates an empty string of zero length ““. An empty string of zero length may be a special type of string in which the number of characters, numerals, and/or symbols in that string equal to zero. Further in this example, operation of the other agent B 202 has been modified such that its respective second output data 116b indicates an identifier for the other agent B 202, the identifier being “{gemma-7b}”, which may in some examples indicate a type of a machine learning model 114b upon which the other agent B 202 is based. Further in this example, operation of the other agent C 203 has been modified such that its respective second output data 116c indicates one or more (referred to herein “k”) predetermined tokens, where the number, k, is 4 and the predetermined token is “[DROP]”.

As referred to herein, a token is any predefined unit of input or output data (i.e., predefined unit of the first input data 102, first output data 106, second input data 112, and/or second output data 116). For example, it is usual for agents to receive and emit data corresponding to words, images, videos, audio (i.e., the tokens), where the tokens belong to a vocabulary of all possible tokens for the agent. As referred to herein, the predetermined token may be a special type of token that indicates a particular function, such as [EOS] indicating an “end of string”—i.e., an end of a piece of text, [SOS] indicating a “start of string”—i.e., a start of a piece of text, or in the example above [DROP] indicating that operation of the other agent C 203 has been modified.

In some examples, the number, k, of predetermined tokens may be determined based upon data indicating an expected number of output tokens for e.g., the other agent 203. For example, the training algorithm or indeed the first agent 100 may maintain statistics about the number of tokens that the other agent 203 usually emits. That is, the data may have been recorded for the other agent 203 during usual operation. In an example, the other agent 203 may, on average, output second output data 116c comprising a total number of 269 tokens. Such statistics may be available to the training algorithm and/or the first agent 100. Accordingly, the number, k, may be selected. In this case, the number, k, may be selected as the average number of tokens (i.e., 269).

The data indicating the expected number of output tokens may, in some examples, be a probability distribution for the expected number of output tokens. That is, a probability distribution may indicate a probability for each possible number of output tokens and the probability distribution may be sampled in order to determine the expected number of output tokens. For example, the probability distribution may be a Gaussian distribution where the mean is the mean number of output tokens that the other agent 203 emits.

In other examples, the predetermined tokens may be generated by having the other agent 203 generate a response without modified operation and further by masking the response with a predetermined token (e.g., “[DROP]”). That is, generating the respective second output data indicating the predetermined tokens may include generating, for the other agent 203, tentative output data (i.e., the second output data 116 without modifying operation of the other agent 203). In this case, the tentative output data may comprise one or more output tokens. For example, the tentative output data could be a full response to a query indicated by the second input data 112, such as “The weather is sunny”, where “The”, “weather”, “is”, “sunny” are the output tokens. Generating the respective second output data indicating the predetermined tokens may further include modifying the tentative output data by replacing the output tokens with the predetermined token. This is referred to herein as “masking”. As a result, in this example, the second output data 116c for the other agent 203 may indicate the predetermined tokens, where the predetermined tokens take the form [DROP][DROP][DROP][DROP] (i.e., k is ‘4’) for the input data “The weather is sunny”.

By generating respective second output data that is indicative of the modified operation indicating the predetermined tokens, positional encodings of the first agent 100 (i.e., of a machine learning model of the first agent) are uninterrupted. Positional encodings, e.g., positional embeddings (i.e., vectors) are used to indicate to a machine learning model a position of one or more tokens in the input. Significant changes in the expected model input (e.g., by reducing otherwise lengthy output from the at least one other agent to, for example, an empty string of zero length or agent identifier) may interfere with positional encodings of the first agent 100 that were learnt during previous training steps. Accordingly, the number, k, of predetermined tokens both indicates the modified operation of the other agent 203 whilst not affecting the positional encodings of the first agent 100 once the second output data 116c is incorporated as input to the first agent 100 for generating the first output data 106.

While the examples above in relation modifying operation of the other agents 201, 202, 203 describe modifying their respective second output data 116a, 116b, 116c directly, other ways of modifying operation of the other agents 201, 202, 203 part of the first set 210 are envisaged. That is, aside from modifying the operation of the other agents 201, 202, 203 to cause the other agent to emit e.g., an empty string of zero length, an identifier, or number, k, of predetermined tokens, modifying the other agent part of the first set 210 may comprise modifying aspects of the machine learning model 114a, 114b, 114c of the respective other agent 201, 202, 203. For example, rather than directly modifying the second output data 116a, 116b, 116c (e.g., by bypassing the machine learning model entirely and replacing its output), the machine learning model(s) 114a, 114b, 114c themselves may be adapted. Machine learning models often determine the next output token in a sequence based upon a probability distribution (e.g., {“The”: 0.54, “cat”: 0.36, “sat”: 0.1, . . . }) for each token in the other agent's vocabulary. A temperature parameter may be used to control the “randomness” of these models. For example, a low temperature parameter such as zero may cause the probability distribution (e.g., the result of a softmax activation function of the machine learning model) for the output tokens to become less flat (i.e., cause the probability distribution to skew more towards the most probable next word in the sequence). In the previous example, a temperature parameter of zero may therefore result in a probability distribution such as {“The”: 1, “cat”: 0, “sat”: 0, . . . }. In other words, in some examples, a low temperature parameter may cause the machine learning model to be more deterministic, whereas a high temperature parameter may cause the machine learning model to be more random. Any suitable temperature parameter is envisaged. In some examples, the temperature parameter may be a value of 0, 0.1, 0.2, 0.3, 0.4, 0.5, 0.6, 0.7, 0.8, 0.9, or 1. In some examples, the temperature parameter may be a value in a range of 0 to 1 or 1 to 5. In some examples, the temperature parameter may be a value in a range of 0 to 0.2, 0.2 to 0.4, 0.4 to 0.6, 0.6 to 0.8, 0.8 to 1, 1 to 1.2, 1.2 to 1.4, 1.4 to 1.6, 1.6 to 1.8, 1.8 to 2, etc. As a particular example, the softmax function including the temperature parameter, T, which generates such a probability distribution may be:

$$\frac{{e}^{\frac{{Z}_{i}}{T}}}{{\sum }_{j} {e}^{\frac{{z}_{j}}{T}}}$$

By adjusting the temperature parameter in this way, the first agent 100 may be trained to not rely upon exact capabilities of the other agents 201, 202, 203 part of the first set 210, and in particular to not rely upon their expected operation.

Alternatively, or in addition, to modify operation of the other agents that are part of the first set 210, the respective second input data (not depicted) to the other agents that are part of the first set 210 may be modified (referred to herein as “hard prompting”). Hard prompting may be used to influence operation of the other agents via the other agents 200 input. For example, the second input data to one of the other agents 200 may be modified to include data indicating “Do not reference any specific knowledge in the field of computer science” to modify operation of the other agent 201. That is, the second input data 112 may be data indicating “What is a function?” and this may be modified to indicate “What is a function? Do not reference any specific knowledge in the field of computer science”.

In another example, an embedding (i.e., an embedding vector) of the second input data may be modified to include an additional embedding vector (referred to herein as a “soft prompt”). Soft prompts are embedding vectors that are configured to modify operation of the other agents 200. The soft prompt vectors may have been learnt during a training phase (e.g., separate to the training discussed herein) with the objective (i.e., training goal) of causing a machine learning model to exhibit particular types of output in response to receiving an input. For example, a particular soft prompt may be configured to cause the other agents 200 to output Python code in a particular format or other property. This may be achieved by concatenating an embedding of “Write me some code in Python for solving a quadratic equation”, i.e., the second input data 112, with the soft prompt, i.e., another vector, to modify the operation of e.g., the other agent A 201.

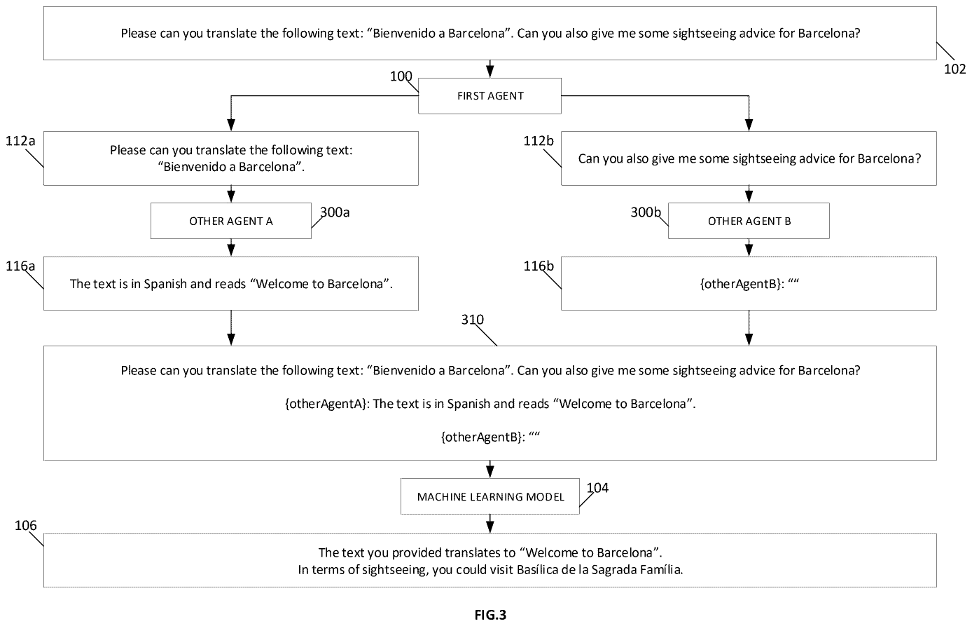

With reference to FIG. 3, there will now be described a practical example of training with multi-agent collaboration and agent dropout. First input data 102 is received by the first agent 100 from a user in the form of an instruction. The first input data 102 indicates “Please can you translate the following text: “Bienvenido a Barcelona”. Can you also give me some sightseeing advice for Barcelona?”. The first agent 100 processes the first input data 102 using the machine learning model 104 and/or the functions 108 to generate two separate inputs, i.e., respective second input data 112a, 112b. As mentioned, the first agent 100 may be configured to output data indicating a function call. Therefore, in this example, the first agent 100 may output, e.g., via the machine learning model 104, text data indicating:

```
        “Please can you translate the following text: “Bienvenido a Barcelona”. Can you also
give me some sightseeing advice for Barcelona?
        {agent: otherAgentA, prompt: ″Please can you translate the following text:
“Bienvenido a Barcelona”.”}
        {agent: otherAgentB, prompt: “Can you also give me some sightseeing advice for
Barcelona?“}”
```

As previously described, the functions 108 of the first agent 100 may parse the text data generated as output and trigger a function call, e.g., a function call to the otherAgentA 300a. The function call may be configured to transmit, e.g., via an API, the second input data 112 “Please can you translate the following text: “Bienvenido a Barcelona”.” to the respective otherAgentA 300a for processing. The otherAgentA 300a may, in response to receiving the second input data 112, generate second output data 116 indicating “The text is in Spanish and reads “Welcome to Barcelona”.”. This second output data 116 may be received by the first agent 100 from the otherAgentA 300a in response.

However, in this example, the otherAgentB 300b may have been selected to be part of the first set 210, i.e., in any suitable way as previously described. Accordingly, it may be determined that operation of the otherAgentB 300b shall be modified, which may in some examples include not executing the respective function call. In examples, the modification may occur prior to the otherAgentB 300b receiving the second input data 112b, i.e., by the training algorithm, or once the otherAgentB 300b receives the second input data 112b, i.e., by the otherAgentB 300b using its functions 118. In this example, the operation of the otherAgentB 300b was modified to cause the output of the otherAgentB to indicate an agent identifier “{otherAgentB}” in addition to an empty string “ ”. In this case, the second output data 116b indicates that operation of the otherAgentB 300b was modified by not indicating a response to the query “Can you also give me some sightseeing advice for Barcelona?”. In the event that the otherAgentB 300b was not part of the first set 210, the second output data 116b may have been a response to the query in the second input data 112b, such as “Barcelona has some fantastic sights to see. I would recommend Basílica de la Sagrada Família, La Rambla, and the Gothic Quarter to name a few.”. The modification of operation of the otherAgentB 300b thus causes the output from the otherAgentB 300b to not include information that the first agent 100 may rely upon for generating the first output data 106.

Once second output data 116 is generated for each of otherAgentA 300a and otherAgentB 300b, the first output data 106 may be generated by the first agent 100. That is, the first agent 100 may generate the first output data 106 based upon the second output data 116 from both the otherAgentA 300a and otherAgentB 300b, including the data indicating the modified operation of the otherAgentB 300b, i.e., data indicating “{otherAgentB}: ““ ”. In this example, an input 310 to the machine learning model 104 of the first agent 100 is generated by the first agent 100 that incorporates data from both of the other agents 300a, 300b. As a result, the input 310 may include data indicating both “{otherAgentA}: The text is in Spanish and reads “Welcome to Barcelona”.” and “{otherAgentB}: ““ ”. In this example, the input 310 also includes the user's original query for context such that the first agent 100 can use the information (or lack thereof in the case of the otherAgentB) provided by the other agents in forming a response to that query. The first output data 106 may then be generated by the first agent 100. For example, the machine learning model 104 of the first agent 100 may process the input 310 to generate the first output data 106. In this example, the first output data 106 indicates “The text you provided translates to “Welcome to Barcelona”. In terms of sightseeing, you could visit Basilica de la Sagrada Familia.”. Subsequently, the first output data 106 may be used to update the first agent 100. Accordingly, the first agent 100 was not able to rely upon information provided by the otherAgentB 300b, e.g., “Barcelona has some fantastic sights to see. I would recommend Basilica de la Sagrada Familia, La Rambla, and the Gothic Quarter to name a few” in generating its response. Thus, the first agent 100 is trained without relying upon the otherAgentB 300b and may learn to generate a response to e.g., “Can you also give me some sightseeing advice for Barcelona?

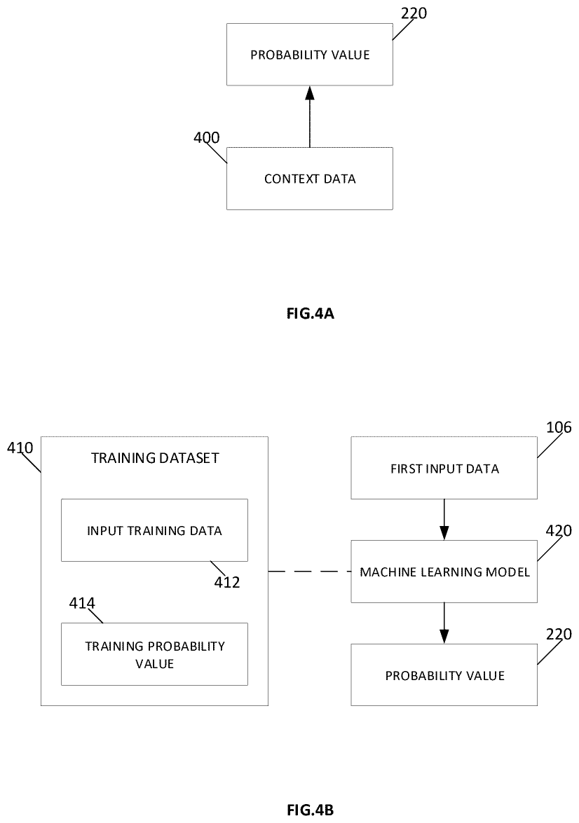

With reference to FIG. 4A and FIG. 4B, further detail regarding the probability value 220 of FIG. 2 is provided, in particular the one or more ways for determining the probability value 220. As previously mentioned, the probability value 220 may be used to determine which of the other agents 200 are part of the first set 210 for modifying their operation. As will now be apparent, the number of the other agents 200 affects the overall output from the first agent 100. That is, the other agents 200 may enhance the performance of the first agent 100, e.g., due to their domain specific capabilities or larger model size. It is thus desirable to select a probability value 220 during training that is optimal. In other words, a probability value 220 that provides the best trade-off between performance, i.e., accuracy, and robustness, i.e., not being overly reliant upon the other agents 200. To this end, the probability value 220 may be determined in one or more of the following ways.

In some examples, the probability value 220 may be a trainable parameter of the first agent 100 (i.e., the machine learning model 104). That is, the probability value 220 may be randomly initialised at the start of training. During a training stage of the first agent 100, e.g., using backpropagation as previously described, the probability value 220 may be updated based upon the output from the first agent 100 (i.e., the first output data 106). Accordingly, the probability value 220, at each training step, may be improved or “tuned” such that a loss value associated with the first agent 100 during training is minimized. Thus, a different probability value 220 may be used at each training step, e.g., based upon how the first agent 100 is updated at the preceding training step. Once training is complete, the probability value 220 that was learnt during training may be used during inference, as described in more detail below.

In some examples, the probability value 220 is a different value for each of the other agents 200. That is, a first one of the other agents 200 may correspond to a probability value of 0.6, whereas another one of the other agents 200 may correspond to a probability value of 0.1. In this way, the trade-off between optimal performance and robustness may be controlled more effectively on an agent-by-agent level.

In some examples, the probability value 220 is determined based upon context data 400, e.g., historical data for the other agents 200. The context data 400 may comprise data indicating whether the other agents 200 will not be available for responding to their respective second input data 112. For example, it may be known during training that one or more of the other agents 200 is unavailable (i.e., not available for receiving input and/or generating output) on average 30% of the time. Thus, such data may be provided and used to determine the probability value 220 (in that case, the probability value may be 0.3). In another example, the context data 400 for the other agents 201, 202, 203, 204, 205, 206 may be [0.6, 0.7, 0.1, 0.05, 0.9, 0.35] indicating, inter alia, a 70% chance that the other agent B 202 will not be available to respond to instructions. Accordingly, the probability value 220 for other agent B 202 may be determined to be 0.7. In a simpler example, the context data 400 may comprise data indicating that 50% of any the other agents 200, on average, will not be available (e.g., offline or busy) for responding to an input at any given time. In this example, the probability value 220 may be selected as 0.5. The examples provided above are merely illustrative and it will be appreciated that, in practice, the availability of the other agent(s) may be significantly higher or lower than in the examples provided.

The context data 400 may further comprise data indicating a change in operation of the other agents 200 over time. For example, the context data 400 may further comprise data indicating that the other agent A 201 has decreased in accuracy, e.g., as measured according to one or more benchmarks or an accuracy achieved during further training sessions between a first date “Oct. 3, 2024” and a second date “Oct. 4, 2024”. Accordingly, data indicating a decrease in accuracy over time may be used to determine that the probability value 220 should be increased from e.g., Oct. 4, 2024 onwards to train the first agent 100 to be more robust against changes in operation for other agent A 201. In other examples, the data may indicate a change in randomness of the output emitted from the other agent(s), e.g., the other agent A 201. That is, data indicating a change in certainty of the other agent A's 201 output over time may be obtained and used to determine the probability value 220, e.g., a certainty value for the other agent A's 201 output probability distribution (i.e., a distribution that determines a next token in an output sequence). In other examples, the data indicating a randomness of the output emitted from the other agent(s) 200 over time may include a change in a temperature parameter of the respective other agent 200 over time. In general, any relevant statistics that indicate how operation (e.g., functionality or behaviour) of the other agent(s) 200 has changed with time may be maintained and used. In this way, these statistics may inform the extent to which agent dropout should be applied to account for possible further changes over time.

In some examples, the probability value is determined based upon an accuracy and/or loss value for the first agent 100. That is, an accuracy and/or loss for the first agent 100 may have been recorded during training over multiple previous training steps (i.e., updates). For example, during a first training step, the accuracy value may be 0.67 and the loss value may be 0.345. During a second training step, the accuracy value may be 0.81 and the loss value may be 0.297. In both training steps, a proportion of the other agents 200 may have had agent dropout applied to them. For example, in the first training step, 3 out of 6 of the other agents 200 may be included in the first set 210, whereas in the second training step, 2 out of 6 of the other agents 200 may have been included in the first set 210. Since the accuracy value and loss value achieved in the second training step are more desirable than those achieved in the first training step (i.e., the accuracy value is higher and the loss value is lower), a proportion of the other agents 200 in the second training step to which agent dropout was applied (i.e., 33.3% or 0.333 in this example) may be selected as the probability value 220 for further training.

In other words, the accuracy/loss of the first agent may be monitored over time with respect to a proportion of the other agents 200 to which agent dropout was applied (i.e., a percentage of the other agents that are part of the first set 210). As another example, during training, the first agent 100 may achieve an accuracy of 0.78 and/or a loss of 0.556. In this example, there may be a total of 10 other agents 200, 2 of which being part of the first set 210. As such, the proportion of the other agents that are part of the first set 210 with respect to the total number of the other agents 200 in this example may be 0.2 or 20%. Data may be generated to track such accuracy and/or loss values over time (i.e., over multiple updates) and averaged for each possible proportion. For example, data averaged for multiple updates may be {0.8: {avg_accuracy: 0.67, avg_loss: 0.678}, 0.6: {avg_accuracy: 0.69, avg_loss: 0.669}, 0.4: {avg_accuracy: 0.76, avg_loss: 0.567}, 0.2: {avg_accuracy: 0.78, avg_loss: 0.556}}. That is, for a proportion of 0.6 (i.e., 60% of the other agents 200 dropped out), average accuracy for the first agent 100 may be 0.69. In this example, the data may be used to determine that a proportion of 0.4 or 40% achieves an optimal trade-off between accuracy (or loss) and robustness (i.e., being robust to a change in operation of the other agents 200) because accuracy significantly decreases between a proportion of 0.4 and 0.6 of dropped out other agents 200, whereas average accuracy does not significantly increase by reducing the proportion of dropped out other agents 200 to 20%. The probability value 220 may be determined accordingly, i.e., based upon a proportion corresponding to a particular accuracy and/or loss value. In the example above, the probability value 220 may be determined to be 0.4 based upon the average accuracy value 0.76 and/or average loss value 0.567.

As will become readily apparent with reference to FIG. 5A below, accurately predicting the probability value 220 for a particular input to the first agent 100 during inference is desirable. Accordingly, with reference to FIG. 4B, there is described a machine learning model 420 for outputting a prediction for the probability value 220. The machine learning model 420 may have been trained on a training dataset 410. In some examples, the machine learning model 420 is based upon a pre-trained machine learning model (e.g., the machine learning model 420 is a product of fine-tuning the pre-trained machine learning model based upon the training dataset 410). In some examples, the pre-trained machine learning model is a foundation model (i.e., a pre-trained machine learning model for generic use). In some examples, the machine learning model 420 is a specialised model that has been pre-trained on specific data for a specific purpose (e.g., a dataset specific to agent training including a wide variety of input examples relevant to agent training). In this example, the machine learning model 420 may have undergone further training (i.e., fine-tuning) on the training dataset 410 whilst retaining characteristics obtained from the initial pre-training on the specific data. The training dataset 410 may comprise pairs of input training data 412 and a training probability value 414. The input training data 412 may be the first input data 102 (e.g., user input) and the training probability value 414 may be the probability value 220 (e.g., the probability value 220 that was used during training). That is, a training dataset 412 may be generated or obtained comprising pairs of user input and the probability value 220, e.g., the probability value 220 used for employing agent dropout according to that user input. Once the training dataset 412 is generated (e.g., over multiple training iterations) or obtained (e.g., from storage), the machine learning model 420 may be trained in any suitable way (e.g., supervised training) such that the trained machine learning model 420 may output the probability value 220 for inference (i.e., a prediction of it). In some examples however, the trained machine learning model 420 may be employed for predicting the probability value 220 during further training iterations. However, in implementations, the machine learning model 420 was primarily used during inference.

During training and/or inference, the machine learning model 420 may receive as part of its input a particular prompt for predicting the probability value 220. For example, the prompt may be “Please can you output a prediction for the probability value as a value in a range of 0 to 1”. The prompt may be for predicting the probability value 220 in a specific way, such as by using a few-shot prompting for in-context learning. For example, the prompt may include one or more examples for the model to use, e.g., as a reference, which causes the machine learning model 420 to output the prediction of the probability value 220 in a same or similar format to the number of examples. In this specific example, the number of examples may each be indicative of an example input/output pair of the machine learning model 420 for predicting the probability value 220.

FIG. 5A schematically depicts the first agent 100 provided for inference. FIG. 5B schematically depicts the input 310 provided to the machine learning model 104 during inference. The first agent 100 may have been trained according to one or more of the techniques described above. As previously described, the other agents 200 may change in operation (e.g., become unavailable during inference) at any time, thus agent dropout may have been applied during training. During inference, all of the other agents 200 may be available for receiving input, thus making it desirable to leverage all possible capabilities of the other agents 200. Accordingly, agent dropout is not necessarily applied. During training, however, the techniques described above may cause one or more intermediate outputs (referred to as “activations”) of the machine learning model 104 of the first agent 100 to be upscaled, i.e., a result of training updates where operation of certain other agents 200 was modified. That is, training the first agent 100 using agent dropout may cause specific intermediate outputs, i.e., the activations, of the machine learning model 104 to be greater than what may have been the case if agent dropout was not applied during training. It is therefore desirable to modify these activations to take account of this fact. To this end, the techniques described below with reference to FIG. 5A and FIG. 5B may be employed. Such techniques may also account for a changing and unpredictable number of the other agents 200 that may or may not be e.g., available for operation during inference. In this way, performance of the first agent 100 during inference is enhanced.

As may be the case during training, the first agent 100 receives the first input data 102 (e.g., an input query for the trained first agent 100). In response, the first agent 100 may generate the first output data 106. As will now be readily apparent, the first output data 106 may be generated by identifying one or more other agents (e.g., the other agents 200 of FIG. 2) for responding to the second input data 112, i.e., at least a portion of the first input data 102. As will also be apparent, operation of the other agents 200 may have been modified during training using the probability value 220. For example, the other agents 200 used to generate the second output data 116 during inference may have been trained with the probability value 220 set as 0.2, i.e., a probability of 0.2 that operation of any one of the other agents 200 will change/be modified. To address the problems mentioned in the foregoing paragraph, one or more activations of the machine learning model 104 may be modified based upon the probability value 220. That is, the activations of the machine learning model 104 produced upon providing the input 310 as input to the machine learning model 104. In particular, the specific outputs(s) from an attention layer of the machine learning model 104 corresponding to output received from the other agents 200 may be modified (e.g., those outputs that map to part of the input 310 that correspond to the second output data 116 generated by the other agents 200). This is desirable because it is those output(s) in particular that may have been upscaled as a result of the training stage with agent dropout, as previously described. In this case, the probability value 220 may indicate a probability that operation of the other agent(s) 200 was modified during a training phase. In an example, if the probability value 220 was 0.2 during training, it may be desirable to modify the relevant output(s) based upon a value of 0.2. This could include multiplying the activations produced by e.g., the attention layer by 0.2 or another factor derived therefrom. In this way, a scaling factor (i.e., the probability value 220) is provided for enabling the intermediate outputs of the machine learning model 104 to be downscaled.

As depicted in FIG. 5B, the second output data 116 (i.e., data received from the other agents 200) may comprise one or more tokens 510a, 510b, 510c, 510d, 510e. For example, the second output data 116 may be “A neural network is a type of machine learning model”. In this example, a token may be data, such as corresponding numeral, indicating “A”, “neural”, “network”, “is”, “a”, “type”, “of” “machine”, “learning”, and “model”. The tokens may correspond to one or more of the other agents 200 (e.g., other agent A 201). That is, the tokens may correspond to the other agents 200 that generated them. Likewise, the tokens may also correspond to the probability value 220 that is associated with the other agent that generated them. For example, the other agent A 201 may have generated “A”, “neural”, “network”, “is”, “a”, “type”, “of” “machine”, “learning”, and “model” and may also have had agent dropout applied during training using a probability value 220 of 0.2. Accordingly, each of the foregoing tokens may correspond to the probability value 220 of 0.2. To determine which tokens in the input 310 corresponds to a particular other agent 200, the first agent 100 may maintain a mapping between tokens in the input 310 and the other agents 200 that generated them (e.g., the particular other agent 200 that the second output data 112 was received from). For example, the second output data 112 may be received by the first agent 100 from the other agent A 201. In response, the first agent 100 in this example may record a mapping between tokens in the second output data 112 and the other agent A 201, such as {agent: otherAgentA, tokens: [“A”, “neural”, “network”, “is”, “a”, “type”, “of” “machine”, “learning”, “model”], positions: [0, 1, 2, 3, 4, 5, 6, 7, 8, 9]}, where “positions” are the relative positions of the tokens in the input 310 with respect to other tokens (e.g., those received from other agent B 202 or generated by the first agent 100 itself). In addition, the first agent 100 may also maintain a mapping between each of the other agents 200 and their respective probability value 220, e.g., the probability value 220 used to apply agent dropout during training. For example, the mapping may be {otherAgentA: 0.2, otherAgentB: 0.6, otherAgentC: 0.1}. Accordingly, tokens that correspond to the other agents 200 whose operation was modified during training based upon the probability value 220 may be determined. Such a correspondence between the other agents 200 or the probability value 220 and their respective tokens in the second output data 112 may be determined in any suitable way.

Upon providing the tokens 510a, 510b, 510c, 510d, 510e as part of input 310 to the machine learning model 104, the tokens 510a, 510b, 510c, 510d, 510e may be provided as input to the attention layer 500 of the machine learning model 104. The attention layer 500 may comprise one or more parameters for generating outputs based upon the tokens (i.e., including the tokens of the second output data 112) in the input 310. That is, those parameters may be used to generate a latent output based upon the input 310. Such latent output may be used as a further input for proceeding and intermediate layers of the machine learning model 104. The resulting outputs may be downscaled, e.g., by multiplying each relevant output by the probability value 220 or by some factor derived thereof. For example, the output(s) that are adjusted may be outputs 500a, 500b, 500c, 500d 500e. In other words, any of the outputs that correspond to the tokens 510a, 510b, 510c, 510d, 510e (i.e., those derived from the second output data 112) in the input 310 may be modified. The remainder of the outputs e.g., outputs 500f, 500g, 500h of the attention layer 500 may remain unmodified. As a result of such modification, the effect described above, i.e., of upscaled outputs, may be remediated. The techniques described above with respect to FIG. 5A and FIG. 5B may be applied to one or more attention layers of the machine learning model 104. However, in implementations, these techniques were applied to the first attention layer only.

The probability value 220 used during inference may be the same probability value 220 used during training. However, in some examples, the probability value 220 used during training may not be known. As will now be apparent, the machine learning model 420 (referred to as “hypernetwork”) described with reference to FIG. 4B may be used to generate a prediction for the probability value 220 during inference. That is, the trained machine learning model 420 may receive the first input data 102 as input and in response output the probability value 220, i.e., a prediction thereof, for modifying the relevant output(s). Accordingly, the probability value 220 is provided by the machine learning model 420 for modifying the relevant output(s) as described above. In other examples, the probability value 220 used during inference may be determined based upon availability data indicating whether one or more of the other agents 200 are not available for responding to input. That is, any one of the other agents 200 may be unavailable or busy (e.g., due to system maintenance). In an example, the availability data may be {otherAgent1: {“available”: False}, otherAgent2: {“available”: True}, otherAgent3: {“available”: False}, otherAgent4: {“available”: True}}. Such availability data may be received via any suitable means (e.g., from the other agents 200 themselves in response to an API call). In this example, the availability data may be used to determine that half (i.e., 0.5) of the other agents 200 are available for responding. However, the probability value 220 used during training may have also been 0.5. In this case, the availability data may be used to determine that no modification of the output(s) is required because the conditions during inference correspond to the conditions during training (i.e., the conditions resulting from applying agent dropout). By utilising availability data in this way, outputs of the machine learning model 104 may be dynamically adapted taking into account current availability of the other agents 200 during inference.

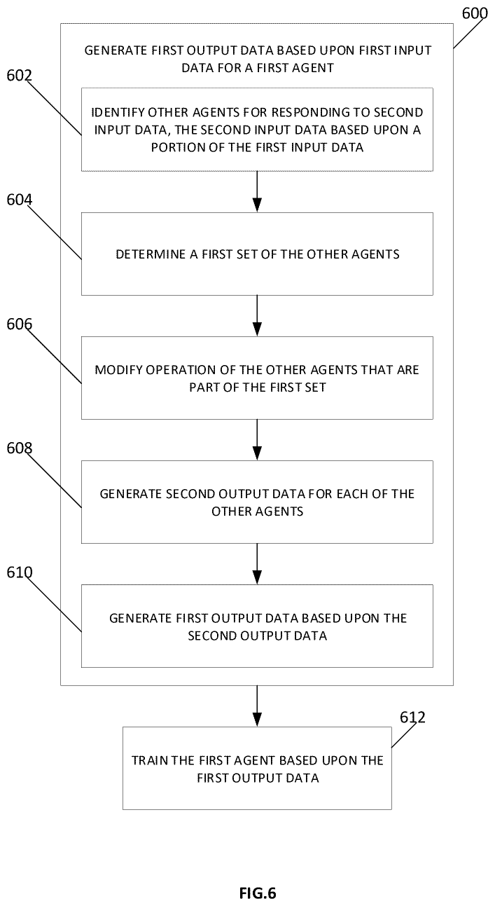

FIG. 6 depicts a flow diagram of a method for training a first agent for performing a task using multi-agent collaboration.

At step 600, the method comprises generating, by the first agent, first output data based upon the first input data for the first agent. Generating, by the first agent, first output data based upon the first input data for the first agent comprises steps 602 to 610.

At step 602, the method comprises identifying one or more other agents for responding to respective second input data, the respective second input data based upon at least a portion of the first input data.

At step 604, the method comprises determining a first set of the one or more other agents comprising at least one of the one or more other agents, the first set determined based upon a value indicating a probability that operation of the one or more other agents shall be modified.

At step 606, the method comprises modifying the operation of the one or more other agents part of the first set, wherein modifying the operation comprises modifying a process of each other agent in the first set for generating respective second output data.

At step 608, the method comprises generating, for each of the other agents, the respective second output data, wherein the respective second output data generated for the one or more other agents part of the first set is indicative of the modified operation.

At step 610, the method comprises generating the first output data based upon the second output data.

At step 612, the method comprises training the first agent based upon the first output data.

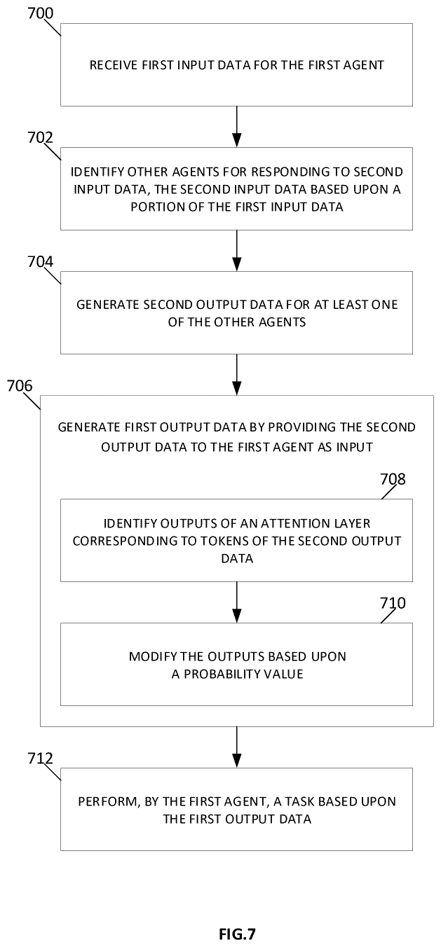

FIG. 7 depicts a flow diagram of a method for performing a task using multi-agent collaboration.

At step 700, the method comprises receiving, by a first agent, first input data for the first agent, the first agent comprising a first machine learning model, the first machine learning model including an attention layer.

At step 702, the method comprises identifying one or more other agents for responding to respective second input data, the respective second input based upon at least a portion of the first input data.

At step 704, the method comprises generating, for at least one of the other agents, respective second output data based upon the respective second input data for the at least one other agent, the respective second output data comprising at least one token. The at least one other agent corresponds to a probability value indicating a probability that operation of the one or more other agents was modified during a training phase of the first agent.

At step 706, the method comprises generating first output data by providing at least the second output data as input to the first agent. Generating the first output data comprises the steps 708 and 710.

At step 708, the method comprises identifying one or more outputs of the attention layer corresponding to the at least one token.

At step 710, the method comprises modifying the one or more outputs based upon the probability value.

At step 712, the method comprises performing, by the first agent, the task based upon the first output data.

Further aspects are defined in the following clauses:
1. A computer-implemented method for training a first agent for performing a task using multi-agent collaboration, the method comprising: generating, by the first agent, first output data based upon first input data for the first agent; and training the first agent based upon the first output data; wherein generating the first output data comprises: identifying one or more other agents for responding to respective second input data, the respective second input data based upon at least a portion of the first input data; determining a first set of the one or more other agents comprising at least one of the one or more other agents, the first set determined based upon a value indicating a probability that operation of the one or more other agents will change; modifying the operation of the one or more other agents in the first set, wherein modifying the operation comprises modifying a process of each other agent in the first set for generating respective second output data; generating, for each of the other agents, the respective second output data, wherein the respective second output data generated for the one or more other agents in the first set is indicative of the modified operation; and generating the first output data based upon the second output data.
2. The method of any preceding clause, wherein the value is a different value for each of the one or more other agents.
3. The method of any preceding clause, wherein training the first agent based upon the first output data comprises updating the value.
4. The method of any preceding clause, wherein the value is determined based upon data indicative of: whether the one or more other agents will not be available for responding to the respective second input data; and/or a change in operation of the one or more other agents over time.
5. The method of any preceding clause, wherein the value is determined based upon an accuracy value indicative of an accuracy for one or more previous updates of the first agent and/or a loss value indicative of a loss for the one or more previous updates of the first agent; wherein the accuracy value and loss value correspond to a proportion of the other agents that are part of the first set with respect to a total number of the other agents.
6. The method of any preceding clause, wherein modifying the operation of the one or more other agents in the first set comprises preventing the other agents in the first set from contributing to the generation of the first output data.
7. The method of any preceding clause, wherein the respective second output data generated for the one or more other agents part of the first set is indicative of the modified operation by indicating: an empty string of zero length, an identifier for the respective other agent, or a number, k, of predetermined tokens.
8. The method of clause 7, wherein the number, k, is determined based upon data indicative of an expected number of output tokens corresponding to the other agent part of the first set that generated the respective second output data.
9. The method of clause 8, wherein the data indicative of an expected number of output tokens comprises a probability distribution for the expected number of output tokens.
10. The method of clause 7 to 9, wherein generating the respective second output data indicating the number, k, of predetermined tokens comprises: generating, for each of the other agents that are part of the first set, tentative output data based upon the respective second input data, the tentative output data comprising one or more output tokens; and modifying the tentative output data by replacing each of the one or more output tokens with a predetermined token to generate the respective second output data indicating the number, k, of predetermined tokens.
11. The method of any preceding clause, wherein modifying the operation of the one or more other agents part of the first set comprises: adjusting a temperature parameter for each of the other agents that are part of the first set; modifying the respective second input data for each of the other agents that are part of the first set; and/or modifying, for each of the other agents that are part of the first set, an embedding vector of the respective second input data in a machine learning model of the respective other agent that is part of the first set.
12. The method of any preceding clause, wherein identifying the one or more other agents for responding to a respective second input data comprises: processing the first input data using a first machine learning model of the first agent, the first machine learning model, in response, further determining the respective second input data for each of the one or more other agents.
13. The method of any preceding clause, further comprising: training a second machine learning model to output a prediction for the value based upon a training dataset, the training dataset comprising: input training data indicating an input for at least one of the other agents; and a training value indicating a probability that the at least one other agent will not be available for responding to an input; and outputting the trained second machine learning model for use.
14. The method of any preceding clause, further comprising, for each of the other agents: generating, for the respective other agent, third output data based upon third input data for the respective other agent; training the respective other agent based upon the third output data; wherein generating the third output data comprises: identifying one or more second other agents for responding to respective fourth input data, the respective fourth input data based upon at least a portion of the third input data; wherein the one or more second other agents comprise the first agent and the one or more other agents exclude the respective other agent; determining a second set of the one or more second other agents comprising at least one of the one or more second other agents, the second set determined based upon a second value indicating a probability that operation of the one or more second other agents shall be modified; modifying the operation of the one or more other agents part of the second set; generating, for each of the second other agents, respective fourth output data, wherein the respective fourth output data generated for the one or more other agents part of the second set is indicative of the modified operation; and generating the third output data based upon the fourth output data.
15. The method of any preceding clause, wherein the first input data comprises text data, image data, audio data, video data, sensor data, and/or time-series data; wherein the first output data comprises text data, image data, audio data, video data, signal data, and/or categorical data; and wherein the task comprises a classification task, a control task for a robotic device, a machine translation task, a summarization task, a question-answering task, a data generation task, or a signalling task.
16. The method of any preceding clause, wherein the task is a task for a real-world environment, and wherein the first agent is configured to control one or more mechanical and/or electronic devices for performing the task in the real-world environment.
17. A computer-implemented method for performing a task using multi-agent collaboration, the method comprising: receiving, by a first agent, first input data for the first agent, the first agent comprising a first machine learning model, the first machine learning model including an attention layer; identifying one or more other agents for responding to respective second input data, the respective second input based upon at least a portion of the first input data; generating, for at least one of the other agents, respective second output data based upon the respective second input data for the at least one other agent, the respective second output data comprising at least one token; wherein the at least one other agent corresponds to a value indicating a probability that operation of the one or more other agents was modified during a training phase of the first agent; generating first output data by providing at least the second output data as input to the first agent, wherein generating the first output data comprises:
identifying one or more outputs of the attention layer corresponding to the at least one token; and
modifying the one or more outputs based upon the value; and
performing, by the first agent, the task based upon the first output data.
18. The method of clause 17, wherein modifying the one or more outputs based upon the value comprises downscaling the one or more outputs based upon the value, wherein the one or more outputs are one or more attention layer activations of the attention layer.
19. The method of clause 17 or 18, wherein the value is determined by providing the first input data as input to a trained machine learning model to output the value.
20. The method of any of clauses 17 to 19, further comprising determining the value based upon availability data indicating whether the at least one of the other agent is not available for responding to input.
21. A computer-implemented method for performing a task using multi-agent collaboration, the method comprising: receiving, by a first agent, first input data for the first agent; generating, by the first agent, first output data based upon the first input data for the first agent; wherein generating the first output data comprises: identifying one or more other agents for responding to respective second input data, the respective second input based upon at least a portion of the first input data; generating, for at least one of the other agents, second output data based upon the respective second input data for the at least one other agent; and generating first output data by providing at least the second output data as input to the first agent; performing, by the first agent, the task based upon the first output data; and wherein the first agent has been trained according to the method of any one of clauses 1 to 16.
22. A computing system comprising: one or more processors; one or more non-transitory computer-readable media storing computer-readable instructions configured to cause one or more processors to perform a method according to any one of the preceding clauses.
23. One or more non-transitory computer-readable media storing computer-readable instructions configured to cause one or more computing devices to perform a method according to any one of clauses 1 to 21.
24. A distributed computing system comprising: a first computing device implementing a first agent, the first agent configured to process first input data to generate first output data, the first agent trained according to the method of any one of clauses 1 to 16; a second computing device implementing another agent, the other agent configured to process second input data to generate second output data; and wherein the second computing device is further configured to receive the second input data from the first computing device over a computer network and to transmit the second output data to the first computing device over the computer network.

In general, the machine learning models described herein can have any appropriate architecture for processing inputs to generate an output. As one example, the machine learning models may comprise an auto-regressive generative model that can auto-regressively generate an output sequence based on the input. The generative model can, for example, comprise a large language model (LLM) that can auto-regressively generate tokenized representations of text data, a vision-language model (VLM) that can auto-regressively generate tokenized representations of image or video data, e.g., in response to a text input or that can auto-regressively generate tokenized representations of text, e.g., in response to an image input, an audio language model that can auto-regressively generate tokenized representations of text data, or a multimodal model that can that can generate tokens representing any of text, image or audio, e.g., in response to a input comprising any of text, image or audio, and so forth. As one example, the generative model may comprise one or more (self-) attention layers, e.g., a Transformer model.

That is, the machine learning models described herein may comprise a neural network characterized by having a succession of attention neural network layers (e.g., a self-attention neural network layer). A self-attention neural network layer has an attention layer input for each element of the input sequence and is configured to apply an attention mechanism over the attention layer input to generate an attention layer output for each element of the input sequence. The attention layer input and the attention layer output may comprise vectors of the same dimension, and the attention neural network layers may have residual connections. There are many different types of attention mechanisms that are be suitable for use with the techniques described herein, such as self-attention, multi-headed attention, cross-attention, etc. A self-attention layer can be one that maps a query and a set of key-value pairs, each derived from an input to the self-attention layer (e.g., all vectors), to an output from which an output of the self-attention layer is derived. The output can be computed as a weighted sum of the values, weighted by a similarity function of the query to each respective key.

As an example, in a self-attention neural network layer an input embedding may be used to determine a query vector and a set of key-value vector pairs, that are used to generate an updated embedding comprising a weighted sum of the values, weighted by a similarity function of the query to each respective key. The similarity function may comprise, e.g., a dot product, cosine similarity, or other similarity measure; the query, keys, and values may all be vectors. For example the attention mechanism may be configured to apply each of a query transformation e.g., defined by a matrix W^{Q}, a key transformation e.g., defined by a matrix W^{K}, and a value transformation e.g., defined by a matrix WV, to the attention layer input for each element of an input sequence X to derive a respective query vector Q=XW^{Q}, key vector K=XW^{K}, and value vector V=XW^{V} which are used determine an attended sequence for the output.

As will now be apparent, the attention layer input may be the input 310, or an input derived therefrom such as an embedding, as described with reference to FIG. 5B. Likewise, the outputs of the attention mechanism, e.g., the keys, the queries, the values, and other outputs derived therefrom such as a dot product of the queries and keys or scaled attention scores, may be the outputs 500a-500h described with reference to FIG. 5B.

As described herein, the inputs and outputs may comprise tokens. In some implementations, the tokens can represent text, e.g., words, wordpieces or characters, in a natural or computer language. For example, text may be received, e.g., as a series of encoded characters, e.g., UTF-8 encoded characters; such “characters” can include Chinese and other similar characters, as well as logograms, syllabograms and the like. A text encoder, i.e., a tokenizer, can process a sequence of text to represent the text as a series of text tokens from a vocabulary of text tokens, e.g., that each represent words, wordpieces or characters in a natural or computer language. The computer language may be any formal language used to communicate with a computer, e.g., a markup language, or a command or configuration language, or a data exchange language such as JSON, or a programming language. The tokenizer can, e.g., implement BPE (Byte Pair Encoding) or Wordpiece tokenization. Optionally the text can be obtained from audio data representing speech; the output tokens may be converted into audio data that represent speech corresponding to the text.

Also or instead the tokens may represent an image. For example, a set (sequence) of input or output tokens can represent an image. Each image token may comprise a block encoding of values of the pixels in a different region of an image that maps a set of values of the pixels to a respective image token. The block encoder may comprise a neural network, e.g., having one or more (self-) attention layers, such as a Transformer neural network as previously described.

Also or instead the tokens may represent an audio waveform. For example, a set (sequence) of input or output tokens can represent audio data representing a waveform e.g., instantaneous audio amplitude values or time-frequency audio data. Each image token may comprise a block encoding of the audio waveform in a different time segment of the audio that maps a set of values representing the audio waveform to a respective image token.

As described herein, the agents may comprise a machine learning model such as a language model, a language model neural network is a neural network that has been trained so that, given a text prompt that includes a sequence of tokens in a natural language, the neural network can generate the next token in the sequence. This process can be repeated to extend the text prompt one token at a time to generate a natural language output, i.e., to generate the natural language output auto-regressively token by token. At each time “time step,” the language model neural network processes the current sequence to generate a probability distribution over a vocabulary of tokens. The next token can then be selected using the probability distribution, e.g., by sampling from the distribution using nucleus sampling or another sampling technique or by selecting the highest-probability token. The tokens in the vocabulary can include any of a variety of tokens, e.g., some combination of words, sub-words, characters, punctuation and other symbols, and numbers. In general, the language model neural network is trained on a corpus of text made up of tokens from the vocabulary (and optionally other tokens that can be mapped to a designated out-of-vocabulary token), to predict the next token in a sequence of tokens from the training data.

A language model neural network can be made to perform a particular task by providing a natural language description of the desired response as an input or “prompt”. In some cases, the prompt may be a few-shot prompt where a few, e.g., 1 to 10, examples of a query and an example output are provided in the text prior to the actual query.

Instead or in addition, a language model neural network may be “fine-tuned” to perform a particular task, by obtaining a pre-trained language model neural network trained on a large corpus of examples as previously described and then further training part of all of the language model neural network on a relatively small number of examples particular to the type of task that is to be performed.

The language model neural network may be a large language model neural network, e.g., one that has greater than 1 billion, 10 billion or 100 billion trained parameters. The language model neural network may have been trained on greater than 10 billion, 100 billion or 1000 billion words or tokens representing words or other text tokens, e.g., sub-words (also known as “word pieces”).

In some implementations, the language model neural network is an autoregressive transformer neural network as previously described.

The task, as referred to herein, may include any suitable task that may be performed based upon the first output data 106. The task may include a classification task such as classifying the first input data 102 (i.e., text classification, image classification, audio classification, video classification, sensor classification, or time-series classification). For example, the first input data 102 could be time-series data and the task could be to classify that time-series data into one or more categories by outputting categorical data. The task may include a control task for a robotic device. For example, the first output data 106 may include signal data that causes the robotic device to be controlled (i.e., by providing the signal data to the robotic device). The task may include a machine translation task. For example, the first input data 102 could include text data representing text in a first language and the first output data 106 could include text data representing a natural language translation of that text in a second language. The task may include a summarization task. For example, the first output data 106 could be text data indicating a summary of some text represented by the first input data 102. The task may include a question-answering task. For example, the first input data 102 could include text data indicating a question “What is this a picture of?” and image data indicating an image of an elephant. In this example, the first output data 106 may be text data indicating a response to the question including an answer that indicates “The picture is of an elephant”, or indeed the first output data 106 could be categorical data indicating a classification of an elephant. The task may include a generation task, i.e., a task for generating data. For example, the first input data 102 may be image data indicating an image of an elephant and the first output data 106 may be video data indicating a video of the elephant, i.e., where the first agent 100 has been trained to generate videos based upon images. The task may include a signalling task. For example, the first input data 102 could be audio data indicating a user speaking the words “Please schedule a meeting for next Monday” and the first output data 106 could be a signal to a client device of the user which causes a meeting to be scheduled in a digital calendar of the client device.

In some examples, the task is a task for a real-world environment. That is, the first agent 100 may be trained to perform tasks in the real-world environment. For example, the task could include tasks in the field of autonomous self-driving, industrial robotics, healthcare, smart homes, agriculture, environmental monitoring etc. To perform tasks in the real-world environment, the first agent 100 may be configured to control (e.g., by outputting a signal as previously described) one or more mechanical and/or electronic devices for performing the task in the real-world environment. The mechanical and/or electronic devices are devices configured to perform specific tasks utilizing electrical and/or mechanical systems. Electronic devices may operate by e.g., using electrical circuits including components such as transistors, diodes, and microprocessors (e.g., to process instructions for controlling the mechanical and/or electronic device) to perform the task. Mechanical devices may operate by e.g., using physical movement and mechanical forces to perform the task. Mechanical devices may, in some examples, include gears, levers, motors, end effectors, etc. An example electro-mechanical device may be the robotic device as previously described, where the robotic device includes a circuit for processing instructions derived from output from the first agent 100 and an end effector for performing a task, such as operating a lever arm in the real-world.

The first agent 100 may be trained to perform tasks such as placing reservations (e.g., travel reservations) on behalf of users (e.g., using signal data for a signalling task), understanding different natural languages, understanding many technical, scientific, or mathematical concepts, etc. In some examples, the first agent 100 may be a personal agent for a user of a client device. The first agent 100 may be implemented on the client device. The first agent 100 may be configured to control operation of the client device (e.g., using the signal data) in response to input (e.g., input provided to the first agent 100 by the user), e.g., for placing reservations on behalf of the user. The other agent 110 (or other agents 200) may, in some examples, not be a personal agent and may therefore be implemented elsewhere (e.g., on a server). However, in other examples, the other agent 110 may be a personal agent for another person other than the user. In some examples, the first agent 100 may interact with the other agent 110 to perform various tasks, e.g., by gathering information relevant to the other person. For example, the first agent 100 which is personal to the user of the client device may interact with the other agent 110 for receiving second output data 116 to schedule a meeting in a calendar of the client device. The second output data 116 may be relevant to the other person, e.g., indicating a calendar for the other person. Accordingly, the first agent 100 can generate first output data 106 that takes into account information relevant to the other person, e.g., such that a meeting can be scheduled in the client device of the user that does not conflict with either person's calendars.

The robotic device, as described above, may take various forms, including but not limited to a telepresence robot, a robotic arm, a bi-arm robotic device, a humanoid robot or other bipedal robot, a quadraped robot such as a “robot dog”, a wheeled robot, an aquatic robot, and so forth. The robotic device may include control logic. Control logic may take various forms, such as a real time controller, one or more processors, one or more field-programmable gate arrays (“FPGA”), one or more application-specific integrated circuits (“ASIC”), and so forth. In some implementations, the logic may be operably coupled with memory. Memory may take various forms, such as random-access memory (“RAM”), dynamic RAM (“DRAM”), read-only memory (“ROM”), Magnetoresistive RAM (“MRAM”), resistive RAM (“RRAM”), NAND flash memory, and so forth. In some implementations, the control logic may be operably coupled with one or more joints, one or more end effectors, and/or one or more sensors. A joint of a robot may broadly refer to actuators, motors (e.g., servo motors), shafts, gear trains, pumps (e.g., air or liquid), pistons, drives, propellers, flaps, rotors, or other components that may create and/or undergo propulsion, rotation, and/or motion. An end effector may broadly refer to a variety of tools that may be operated by the robotic device in order to accomplish various tasks. For example, an end effector may take the form of a claw with two opposing “fingers” or “digits.” Such a claw is one type of “gripper” known as an “impactive” gripper. The gripper may have more than two digits, for example, three, four or five digits. Other types of grippers may include but are not limited to “ingressive” (e.g., physically penetrating an object using pins, needles, etc.), “astrictive” (e.g., using suction or vacuum to pick up an object), or “contigutive” (e.g., using surface tension, freezing or adhesive to pick up object). More generally, other types of end effectors may include but are not limited to drills, brushes, force-torque sensors, cutting tools, deburring tools, welding torches, containers, trays, and so forth. In some implementations, end effector may be removable, and various types of modular end effectors may be installed onto robot. Some robots, such as some telepresence robots, may not be equipped with end effectors.

Large-scale language models implemented as neural networks can produce impressive results on a range of natural language processing tasks, including question answering. However, implementations of some these models, particularly Transformer-based models, can have more than a billion parameters and can require substantial computing resources, power, and time to process a network input to generate the network output. Sometimes such models can have can more than 10 billion or more than 100 billion parameters. If such models were used at scale, e.g., in the way that search engines are, there could also be environmental considerations.

An additional consideration arises when the neural network is implemented on a digital assistant device, e.g., a mobile device, implemented in a computing system that includes a back end component, in particular a data server, in communication with the digital assistant device over a data communications network such as the Internet. There is then a need to optimize the computing load between the digital assistant device and the back end component. This need can be particularly acute with a large-scale language model because of its substantial memory and computing requirements compared with those typically found on a mobile device.

The techniques described herein address these problems. In some implementations the described techniques facilitate a reduced a computational load, and improved load distribution, particularly when the large-scale language model is implemented as a neural network in a multitasking and parallel processing computer system, distributed across multiple sites and interconnected by a data communication network, such as the multi-agent system described herein.

In some implementations the described techniques enable a beneficial distribution of computing load between a local, mobile computing device and a back-end server in a network. More particularly, in implementations, by training the agents, e.g., the first agent 100, for multi-agent collaboration and with agent dropout, utilisation of other agents and thus computational load may be managed more effectively.

In some implementations the ego agent may be implemented on a digital assistant device such as a mobile device. In such implementations the ego agent can be implemented (wholly) on the mobile device. Subsequent inputs (e.g., the second input data 112) can be processed using a back-end data server by the other agents for multi-agent collaboration, as previously described, which may be implemented using a parallel and distributed computing system. The mobile device generally has less working memory than the back-end data server, less computational capacity than the back-end data server, or both. Computational capacity can be measured in computing operations per second, e.g., FLOPS (floating point operations per second). In this way the computational load can be optimized, particularly where the neural network comprises an autoregressive, Transformer-based neural network. This in turn can facilitate using a smaller language model, e.g., one with fewer than 10bn parameters, e.g., 7bn parameters, 1bn parameters, or fewer.

In general, the agent and/or multi-agent system as a whole, once trained on a large corpus of data, and even without fine tuning, can perform a wide range of tasks. After such training, the agent(s) can be deployed for use in performing the task(s). For instance, the agent(s) can be deployed in an environment that enables users to provide requests for the agent(s) to process specified multimodal inputs to generate corresponding outputs. Users can provide the requests, e.g., by way of a user interface or through an application programming interface (API). The requests can be transmitted from a user device (e.g., over a data communication network, e.g., the internet) to one or more computers implementing the system, e.g., in a data center. The agent(s) can process multimodal inputs specified by user requests to generate corresponding outputs, and then transmit the outputs to user devices (e.g., over a data communication network).

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The essential elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A computer-implemented method for training a first agent for performing a task using multi-agent collaboration, the method comprising:
generating, by the first agent, first output data based upon first input data for the first agent;
training the first agent based upon the first output data; and
wherein generating the first output data comprises:
identifying one or more other agents for responding to respective second input data, the respective second input data based upon at least a portion of the first input data;
determining a first set of the one or more other agents comprising at least one of the one or more other agents, the first set determined based upon a value indicating a probability that operation of the one or more other agents shall be modified;
modifying the operation of the one or more other agents part of the first set, wherein modifying the operation comprises modifying a process of each other agent in the first set for generating respective second output data;
generating, for each of the other agents, the respective second output data, wherein the respective second output data generated for the one or more other agents part of the first set is indicative of the modified operation; and
generating the first output data based upon the second output data.

2. The method of claim 1, wherein the value is a different value for each of the one or more other agents.

3. The method of claim 1, wherein training the first agent based upon the first output data comprises updating the value.

4. The method of claim 1, wherein the value is determined based upon data indicative of:
whether the one or more other agents will not be available for responding to the respective second input data; and/or
a change in operation of the one or more other agents over time.

5. The method of claim 1, wherein the value is determined based upon an accuracy value indicative of an accuracy for one or more previous updates of the first agent and/or a loss value indicative of a loss for the one or more previous updates of the first agent;
wherein the accuracy value and loss value correspond to a proportion of the other agents that are part of the first set with respect to a total number of the other agents.

6. The method of claim 1, wherein modifying the operation of the one or more other agents in the first set comprises preventing the other agents in the first set from contributing to the generation of the first output data.

7. The method of claim 1, wherein the respective second output data generated for the one or more other agents part of the first set is indicative of the modified operation by indicating:
an empty string of zero length, an identifier for the respective other agent, or a number, k, of predetermined tokens.

8. The method of claim 7, wherein the number, k, is determined based upon data indicative of an expected number of output tokens corresponding to the other agent part of the first set that generated the respective second output data.

9. The method of claim 8, wherein the data indicative of an expected number of output tokens comprises a probability distribution for the expected number of output tokens.

10. The method of claim 7, wherein generating the respective second output data indicating the number, k, of predetermined tokens comprises:
generating, for each of the other agents that are part of the first set, tentative output data based upon the respective second input data, the tentative output data comprising one or more output tokens; and
modifying the tentative output data by replacing each of the one or more output tokens with a predetermined token to generate the respective second output data indicating the number, k, of predetermined tokens.

11. The method of claim 1, wherein modifying the operation of the one or more other agents part of the first set comprises:
adjusting a temperature parameter for each of the other agents that are part of the first set;
modifying the respective second input data for each of the other agents that are part of the first set; and/or
modifying, for each of the other agents that are part of the first set, an embedding vector of the respective second input data in a machine learning model of the respective other agent that is part of the first set.

12. The method of claim 1, wherein identifying the one or more other agents for responding to a respective second input data comprises:
processing the first input data using a first machine learning model of the first agent, the first machine learning model, in response, further determining the respective second input data for each of the one or more other agents.

13. The method of claim 1, further comprising:
training a second machine learning model to output a prediction for the value based upon a training dataset, the training dataset comprising:
input training data indicating an input for at least one of the other agents; and
a training value indicating a probability that the at least one other agent will not be available for responding to an input; and
outputting the trained second machine learning model for use.

14. The method of claim 1, further comprising, for each of the other agents:
generating, for the respective other agent, third output data based upon third input data for the respective other agent;
training the respective other agent based upon the third output data;
wherein generating the third output data comprises:
identifying one or more second other agents for responding to respective fourth input data, the respective fourth input data based upon at least a portion of the third input data;
wherein the one or more second other agents comprise the first agent and the one or more other agents excluding the respective other agent;
determining a second set of the one or more second other agents comprising at least one of the one or more second other agents, the second set determined based upon a second value indicating a probability that operation of the one or more second other agents shall be modified;
modifying the operation of the one or more other agents part of the second set;
generating, for each of the second other agents, respective fourth output data, wherein the respective fourth output data generated for the one or more other agents part of the second set is indicative of the modified operation; and
generating the third output data based upon the fourth output data.

15. The method of claim 1, wherein the first input data comprises text data, image data, audio data, video data, sensor data, or time-series data;
wherein the first output data comprises text data, image data, audio data, video data, signal data, or categorical data; and
wherein the task comprises a classification task, a control task for a robotic device, a machine translation task, a summarization task, a question-answering task, a data generation task, or a signalling task.

16. The method of claim 1, wherein the task is a task for a real-world environment, and wherein the first agent is configured to control one or more mechanical and/or electronic devices for performing the task in the real-world environment.

17. A computer-implemented method for performing a task using multi-agent collaboration, the method comprising:
receiving, by a first agent, first input data for the first agent, the first agent comprising a first machine learning model, the first machine learning model including an attention layer;
identifying one or more other agents for responding to respective second input data, the respective second input based upon at least a portion of the first input data;
generating, for at least one of the other agents, respective second output data based upon the respective second input data for the at least one other agent, the respective second output data comprising at least one token;
wherein the at least one other agent corresponds to a value indicating a probability that operation of the one or more other agents was modified during a training phase of the first agent;
generating first output data by providing at least the second output data as input to the first agent, wherein generating the first output data comprises:
identifying one or more outputs of the attention layer corresponding to the at least one token; and
modifying the one or more outputs based upon the value; and
performing, by the first agent, the task based upon the first output data.

18. The method of claim 17, wherein modifying the one or more outputs based upon the value comprises downscaling the one or more outputs based upon the value, wherein the one or more outputs are one or more attention layer activations of the attention layer.

19. The method of claim 17, wherein the value is determined by providing the first input data as input to a trained machine learning model to output the value.

20. The method of claim 17, further comprising determining the value based upon availability data indicating whether the at least one of the other agent is not available for responding to input.

21. A distributed computing system comprising:
a first computing device implementing a first agent, the first agent configured to process first input data to generate first output data, the first agent having been trained by performing operations comprising:
generating, by the first agent, first training output data based upon first training input data for the first agent; and
training the first agent based upon the first training output data, wherein generating the first output data comprises:
identifying one or more second agents for responding to respective second training input data, the respective second training input data based upon at least a portion of the first training input data;
determining a first set of the one or more second agents comprising at least one of the one or more second agents, the first set determined based upon a value indicating a probability that operation of the one or more second agents shall be modified;
modifying the operation of the one or more second agents that are part of the first set, wherein modifying the operation comprises modifying a process of each second agent in the first set for generating respective second training output data;
generating, for each of the second agents, the respective second training output data, wherein the respective second training output data generated for the one or more second agents that are part of the first set is indicative of the modified operation; and
generating the first training output data based upon the second training output data;
a second computing device implementing another agent, the other agent configured to process second input data to generate second output data; and
wherein the second computing device is further configured to receive the second input data from the first computing device over a computer network and to transmit the second output data to the first computing device over the computer network.
